(19) United States
(12) Patent Application Publication
(10) Pub. No.: US 2008/0246532 A1
(43) Pub. Date: Oct. 9, 2008

(54) METHOD FOR CONTROL OVER MECHANICAL RESONANT SYSTEM

(76) Inventors: James D. COSPER, Goliad, TX (US); Enrique Gutierrez, Littleton, CO (US)

Correspondence Address: MORRISON & FOERSTER LLP, 755 PAGE MILL RD, PALO ALTO, CA, 94304-1018, US

(21) Appl. No.: 12/051,735

(22) Filed: Mar. 19, 2008

Related U.S. Application Data
(60) Provisional application No. 60/922,711, filed on Apr. 9, 2007.

(51) Int. Cl. G05F 1/00

(52) U.S. Cl. 327/518

(57) ABSTRACT

Systems and methods are provided for automatically driving and maintaining oscillation of an assembly system including a mass and a bias member (which may also be referred to as a spring or elastomeric member) at or near a resonant frequency of the assembly system. In one example, apparatus for maintaining oscillation of a moveable subassembly including a mass and a bias comprises a controller operable to receive a signal from a sensor associated with a position or motion of the subassembly, and generate a drive signal for driving the subassembly in response to the received signal from the sensor. In this manner, the controller may monitor the motion of the subassembly and adjust or modulate the driving force over time to maintain the subassembly at or near a resonant frequency. Further, in one example, the subassembly includes a resonant engine comprising a movable mirror of an illumination device.

### CROSS-REFERENCE TO RELATED APPLICATIONS

This patent claims priority to U.S. Provisional Patent application No. 60/922,711, entitled “METHOD FOR CONTROL OVER MECHANICAL RESONANT SYSTEM,” filed Apr. 9, 2007, which is hereby incorporated herein by reference in its entirety for all purposes. This application is further related to previously filed U.S. patent application Ser. No. 11/665,109, entitled “DEVICES AND METHODS FOR EFFICIENT RESONANT,” filed on Apr. 10, 2007, and U.S. provisional patent application Ser. No. 60/922,711, entitled “METHOD FOR CONTROL OVER MECHANICAL RESONANT SYSTEM,” filed on Apr. 9, 2007, both of which are incorporated herein by reference in their entirety as if fully set forth herein.

### BACKGROUND

1. Field

This application generally relates to systems and methods for control of a mass and bias (e.g., “elastomeric members”) subassembly, including oscillating mechanical systems, that operate in an oscillatory mode at or near their mechanical resonant frequency. In one example, the systems are described for use with illumination systems including an oscillating resonant engine.

2. Related Art

Mechanical systems typically have a resonant frequency, a natural frequency at which the system tends to move or oscillate when an impulse is applied. Moving the system at non-resonant frequencies may require significantly more energy. Accordingly, it may be desirable to move and control a mechanical system at or near its resonant frequency to achieve the maximum system movement for a reduced or minimal amount of energy.

The resonant frequency of a mechanical system tends to vary over time, with changes in mass, mechanical or elastomeric properties, ageing, friction, wear or dampening to name but a few. Maintaining a mechanical system moving at its resonant frequency requires significantly less energy, but may involve greater complexity.

Driving a mechanical resonant system for low loss, and a high Q, at or near its resonant frequency using an external frequency references may require a highly stable frequency source. It may also require that the resonant frequency of the mass and spring mechanism itself be very stable. The frequency of the two systems, one mechanical, and one electronic, will typically drift apart over time. Even relatively small variations in frequency between the two systems may cause the amplitude of the mechanical oscillations to decrease significantly.

Accordingly, it may be desirable to incorporate feedback into such systems to eliminate the need for a secondary (external) frequency source such that the natural frequency of the mechanical resonant system becomes the frequency reference. Any variation in the mechanical resonant system that affects its resonant frequency is sensed and tracked by a controller, so that the mechanical resonant system is driven and continues to oscillate at the new resonant frequency.

### BRIEF SUMMARY

The present invention discloses systems and methods for automatically driving (e.g., controlling energy applied) and maintaining oscillation of an assembly including a mass and a bias member (which may also be referred to as a spring or elastomeric member) at a resonant frequency. In one example, apparatus for maintaining oscillation of a moveable subassembly including a mass and bias comprises a controller operable to receive a signal from a sensor associated with a position or motion of the subassembly, and generate a drive signal for driving the subassembly in response to the received signal from the sensor. In this manner, the controller may monitor the motion of the subassembly and adjust or modulate the driving force over time to maintain the subassembly at or near resonant frequency. Further, in one example, the subassembly includes a resonant engine comprising a mirror of an illumination device.

The mass and bias may include any movable assembly having a resonant frequency (or frequencies). In some variations the subassembly is secured to a relatively immobile (or fixed) structure (such as a housing) and the assembly of the mass and bias moves with respect to the structure. The control systems described herein may be embodied as control circuits or drive circuits of a controller. A drive circuit typically functions to compensate for changes in mechanical, electrical or magnetic parameters that may otherwise alter the mechanism's resonant frequency. In general, a mass may be set in motion via an electromagnetic control and drive circuit. Feedback on the position, velocity, and/or acceleration of the mass may be input to the controller. The controller is operable to process the feedback signal and generate drive signals that are processed to maintain mechanical oscillation at the mechanical resonant frequency of the system.

A drive circuit, incorporated with the controller or separate thereto, may function such that it maintains the amplitude of oscillation of the subassembly at a desired amplitude set-point. The drive circuit may allow for an amplitude set-point input for oscillation amplitude adjustability. The drive circuit may function to compensate for mechanical, electrical or magnetic parameter changes that may tend to alter the mechanism's oscillation amplitude set-point. A drive circuit may function such that it can vary the resonant frequency of a mass and spring mechanism by altering the system's restoring force electromagnetically (or via other appropriate means). A drive circuit may function such that it can automatically maintain the resonant frequency of a mass and spring mechanism at a desired frequency set-point.

Any appropriate subassembly may be used with the systems and methods described herein. For example, a controller (including a control circuit) as described herein may be used to control or regulate the oscillation of a device for resonant illumination. Thus, in one example described herein, a control system as described herein may be used to control oscillation of a mirror subassembly for efficient illumination.

The details of one or more embodiments of these control systems, assembly systems, illumination systems, and/or methods of using them are set forth in the accompanying drawing and in the description below. Other features, objects, and advantages of the inventions will become apparent from the description and drawings, and from the claims.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic illustration of an exemplary control system and subassembly systems as described herein.

FIG. 1A shows an illumination pattern of a typically static device. FIG. 1B shows an illumination pattern for a device in which the light from the light source is scanned as described herein.

FIGS. 2A and 2B show schematic cross-sections through a variation of an illumination device as described herein

FIG. 3 shows one arrangement if a resonant illumination system in which multiple mirrors are used.

FIG. 4 shows an exploded three-dimensional view of an illumination device as described herein.

FIG. 5 illustrates a cross-section through the middle of an illumination device similar to the one shown in FIG. 4.

FIG. 6 shows a partial cross-sectional view of an illumination device similar to that shown in FIGS. 4 and 5.

FIG. 7 shows a schematic of an illumination device having an elongated light source (e.g., bulb) and a mirror with a parabolic reflective surface reflecting light from the light source, as described herein.

FIGS. 8A and 8B illustrate another variation of an illumination device as described herein.

FIG. 9A shows a block diagram of one variation of a resonant engine.

FIG. 9B shows a schematic of a resonant engine system.

FIG. 10 is one variation of a resonant engine.

FIGS. 11A-11C show one variation of a bias, configured as a clock spring.

FIGS. 12A-12B show a clock spring to which a rotor is attached.

FIGS. 13A-13D show schematic illustrations of components of a resonant engine, similar to that shown in FIG. 10.

FIGS. 14A-14C show perspective, top and side cut-away views, respectively, of a portion of a resonant engine.

FIGS. 15A-15C is another variation of a resonant engine.

FIG. 16A is one example of a profile of mirror for use with a resonant engine.

FIGS. 16B-16D illustrate scanning of the mirror shown in FIG. 16A.

FIG. 17A is one example of a profile of mirror for use with a resonant engine.

FIGS. 17B-17F illustrate scanning of the mirror shown in FIG. 16A.

FIG. 18A is one example of a profile of mirror for use with a resonant engine.

FIGS. 18B-18F illustrate scanning of the mirror shown in FIG. 16A.

FIGS. 19A-19B illustrate another variation of a resonant engine.

FIG. 19C is an exemplary drive signal for a resonant engine as shown in FIG. 19A-19B.

FIGS. 20A-20B illustrate the operation of a resonant engine such as the resonant engine shown in FIGS. 19A-19B.

FIGS. 21A and 21B show top and side perspective views, respectively, of a mirror that may be used as part of a resonant engine.

FIG. 21C illustrates a reflection pattern for the mirror shown in FIGS. 21A-21B.

FIGS. 22A and 22B show top and side perspective views, respectively, of a mirror that may be used as part of a resonant engine.

FIG. 22C illustrates a reflection pattern for the mirror shown in FIGS. 21A-21B.

FIGS. 23A and 23B show top and side perspective views, respectively, of a mirror that may be used as part of a resonant engine.

FIGS. 24A and 24B show top and side perspective views, respectively, of a mirror that may be used as part of a resonant engine.

### DETAILED DESCRIPTION

The following description is presented to enable a person of ordinary skill in the art to make and use the inventions. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded a scope consistent with the appended claims.

Exemplary systems and methods described herein may include a mass and spring mechanism (subassembly), including one or more mass member(s), where the mass is a part of the mechanism which will oscillate when driven. The subassembly further including one or more elastomeric member(s); for example, a spring, an electrometric band, a plastic member, a rubber member, a metal member, a composite member, a clock spring, or the like. The subassembly further including a means of attaching the elastomeric member to the mass member, a volume, which may be partially or completely enclosed (e.g., within a housing) to allow for a range of motion for the mass to oscillate (for example, in a one dimensional linear or rotational mode of movement; in a two dimensional planer or rotational mode of movement; or in a three dimensional volume or rotational mode of movement). In one particular example provided herein, the mass includes an oscillating mirror assembly.

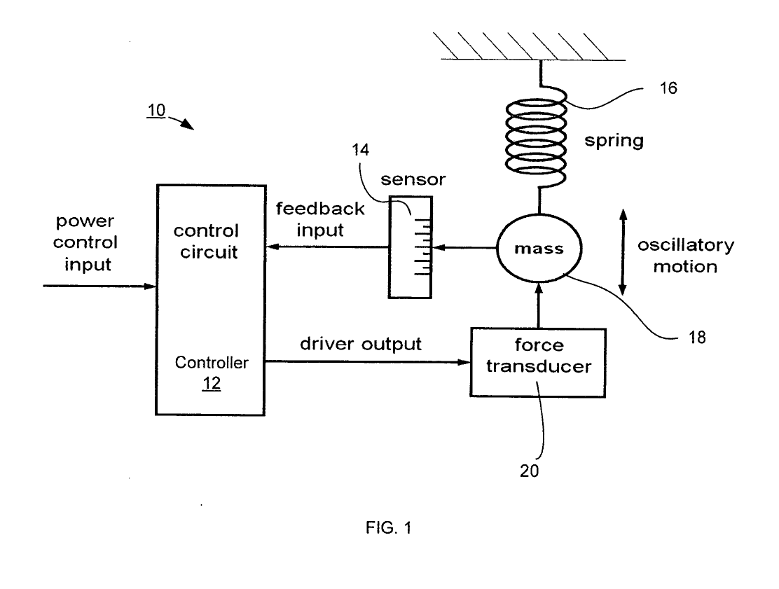

FIG. 1 illustrates schematically an exemplary control system 10 for use with a mechanical resonant subassembly system. In general, the control system 10 described herein includes control logic (e.g., hardware, software, firmware, or combinations thereof included with a controller or control circuit 12), a sensor 14 for determining a parameter from the moveable subassembly (e.g., including a bias 16 and mass 18), a sensor input for inputting the parameter into the control logic of control circuit 12, and a control output from the control logic to drive the moveable subassembly at or near resonance via force transducer 20.

The control logic may be contained within a controller or control circuit 12, and may include one or more feedback inputs from one or more sensors 14. Any appropriate sensor may be used (e.g., optical, magnetic, capacitive, etc.), and may detect any appropriate parameter that may correlate the position of the subassembly (e.g., from which the motion of the subassembly may be derived). For example, one or more sensors 14 may detect position, velocity, acceleration, etc. for the subassembly (e.g., of bias 16 and/or mass 18). In some variations, a sensor 14 is connected to a driver associated with force transducer 20, and senses the load or driving force applied to the subassembly. Sensors 14 may include electrical sensors, electromagnetic sensors, optical sensors, induction sensors, photosensors, or the like (classes of sensors may include: induction, electrical, photo, optical, electromagnetic, motion, ultrasonic, infrared, etc.).

The output from the control logic of control circuit 12 may output (and thus control) a force transducer 20 for applying force directly or indirectly to mass 18. Examples of force transducers include, but are not limited to: motors, electromagnetic drivers (e.g., reciprocal electromagnetic drivers), a voice coil motor, a piezoelectric driver, a solenoid (including a linear solenoid), a menetostrictive driver, a MEMS driver, and the like. The driver is typically matched to the subassembly. For example, if the subassembly includes a magnet, the driver may include an electromagnetic source that applies a magnetic field to act on the magnet (as described with respect to various examples provided herein).

In operation, control circuit 12 receives one or more inputs on the position or motion (or both) of the subassembly, and is operable to output signals to the force transducer 20 for driving the subassembly. In some variations, the control logic also receives input from the force transducer 20, for example, indicating the status or load under which the driver is operating, and which may be used for adjusting output signals to force transducer 20 over time.

The subassembly (bias 16 and mass 18) may be separate from control system 10 or may be included with the system, for example, in a common housing or included with a common base. In addition, control system 10 may include one or more control inputs for controlling the power to the control logic/control circuit 12. For example, control system 10 may include an on/off switch, a control for increasing the oscillation rate (e.g., the resonant frequency or increasing to a new resonant frequency), or any other appropriate control.

In one example, control circuit 12 comprises control logic that may include sensor input conditioning and processing logic, signal phase compensation logic, force transducer driver logic for one or more force transducers, one or more force transducer driver power controls, as well as other well known components for receiving feedback signals and outputting drive signals. In operation, and according to one example, control circuit 12 operates to (1) initiate movement of the subassembly, (2) determine an energy-efficient resonant frequency for operation of the system, and (3) maintain operation of the system at a resonant frequency. In addition, the system may also be adjusted to modify the resonant frequency, or identify another resonant frequency (harmonic) at a faster or lower oscillation rate.

In one example, control circuit 12 operates to maintain the amplitude of oscillation of the subassembly at a desired amplitude set-point. Further, control circuit 12 may further allow for an amplitude set-point input for oscillation amplitude adjustability. In this manner, control circuit 12 may function to compensate for mechanical, electrical, and/or magnetic parameter changes that may tend to alter the mechanism's oscillation amplitude set-point. In operation, control circuit 12 may operate to vary the resonant frequency of a mass and spring mechanism by altering the system's restoring force electromagnetically (or via other appropriate means). Accordingly, control circuit 12 may function to automatically maintain the resonant frequency of a mass and bias subassembly at a desired frequency set-point.

Implementation of the described methods and operations may be carried out via software, hardware, firmware, or any suitable combination thereof. Further, one of ordinary skill in the art will recognize that various algorithms for analyzing feedback signals and driving the resonant subassembly as described are contemplated.

Any appropriate subassembly may be used with the systems and methods described herein. For example, a controller, including a control circuit, as described herein may be used to control or regulate the oscillation of a device for resonant illumination. One exemplary application of the described control system is with an oscillating mirror system that may be used with a light source to provide illumination that is highly effective, and may be energy efficient. For example, an illumination system that oscillates one or more mirrors to light a broad region while operating at or near a resonant frequency or its harmonic. Such devices, systems, and methods are often referred to as “resonant engines,” “resonant lighting,” or “resonant engines for adjustable light.” Thus the systems may be referred to as “R.E.A.L” systems (“resonant engines for adjustable light” systems) or resonant engine systems. The systems are further described, for example, in copending U.S. patent application Ser. No. 11/665,109, entitled “DEVICES AND METHODS FOR EFFICIENT RESONANT,” filed on Apr. 10, 2007, and U.S. provisional patent application Ser. No. 61/028,460, entitled “DEVICES AND METHODS FOR GENERATING BEAM PATTERNS WITH CONTROLLABLE INTENSITY, COLOR OR INFORMATION CONTENT,” filed on Feb. 13, 2008, both of which are hereby incorporated by reference in their entirety as if fully set forth herein.

In general, the resonant illumination devices described herein include a mirror (or multiple mirrors) mounted to a bias. The mirror and bias may form a mirror subassembly that is attached to an engine support (e.g., housing). The mirror subassembly may include additional components (e.g., a rotor or other portion of the mirror driver), and is typically mounted so that it may be moved (e.g., oscillated) in a substantially undamped fashion continuously at or near the resonant frequency of the mirror subassembly. The mirror subassembly may be a single (unitary) component. For example, the mirror and subassembly may be the same component. The devices may also include a mirror driver that provides force to load and unload the bias and move the mirror(s). The mirror driver may also be mounted to the support. The mirror driver may be configured to provide force to move the mirror (or mirror subassembly) at or near a resonant frequency of the mirror and bias combination. In some variations one or more control circuits is included to control the force applied by the mirror driver so that the mirror and bias are moved at or near a resonant frequency and the desired magnitude for the mirror and bias. In some variations, one or more sensor(s) may provide input to the control circuit.

A light source may also be included, either as part of the resonant engine, or as part of a system including the resonant engine. Light from the light source may be reflected by the resonant engine to form a pattern as the resonant engine moves the mirror. The emissions of the light source (or illumination source) are typically guided by the mirror, which moves in an energy-efficient mechanically resonant fashion, directing the emitted light toward a target or in a desired direction, creating an illumination pattern. This larger illumination pattern is formed by the rapid movement of smaller discrete spots, bars or other shapes of illumination, but will typically be seen by an observer as illumination of the entire larger area, and as equivalent to the illumination generated by a higher power illumination source directed over the same area.

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded a scope consistent with the appended claims.

As used herein, the term “mirror” may refer to any appropriate reflective surface. A mirror may be a flat or substantially flat reflective surface, or a curved, elliptical, parabolic, rounded, off-axis, bent or facetted surface. In some variations, the mirror is only partially or selectively reflective. The mirror may be a compound mirror, and may have multiple facets or faces. Examples and further descriptions of mirrors are provided below.

As used herein, the term “bias” may refer to any appropriate element to which may be displaceable, flexible, and/or elastic. Typically, a bias may store mechanical energy during loading when it is moved from a first position, and then release the mechanical energy during unloading when it returns towards the first position. A bias may be an elastic material or a structure having elastic properties (e.g., elasticity or resilience). For example, a bias may be selected from the group consisting of: a spring, an electrometric band, a string, a plastic member, a rubber member, a metal member, and a composite member. One particular example of a bias is a clock spring.

As used herein, the term “light source” may refers to any appropriate source of light, particularly electrically-activated light sources such as lamps, light bulbs, LEDs, coherent light sources, flash lamps, etc. The devices described herein may also be referred to as light or lighting devices, and may be part of an illumination system or light system. The resonant engine devices described herein may be fixed or mounted (e.g., configured to be attached to a surface or object), or they may be hand-held devices, and may be used in any application in which illumination would be useful, particularly in applications in which low-power, wide-range illumination would be useful.

As used herein, the term “engine support” may refer to a support that secures at least one portion of the mirror subassembly, and does not substantially move with respect to the mirror subassembly. In some variations, the engine support is a housing, and may also enclose one or more portions of the device. In some variations, the support is a framework (e.g., a rigid framework) or scaffolding. The support may not fully enclose any portion of the device. An engine support may be mountable in order to fix the device in place, or may include a stand or base for positioning the resonant engine. Although the term “housing” is used throughout this description, it should be clear that any of the embodiments referred to as including a “housing” may instead (or in addition) include the more general “engine support.”

The devices described herein typically include a mirror and may be used with (or may include) a light source. In most variations, the light source does not move with respect to the mirror, while the mirror is capable of moving at a resonant frequency. Resonance is the tendency of a system to absorb more energy when the frequency of its motion (e.g., oscillation or vibration) matches the system's natural frequency of vibration (its resonant frequency) than it does at other frequencies. The resonant frequency of the mirror and bias may be determined based on the materials used to form them, and their arrangement, and may be calculated or determined experimentally. There is usually a “family” of resonant frequencies for the mechanical system of the illumination device (e.g., harmonics). In general, the illumination devices described herein may move the mirror at a resonant frequency that is greater than the average threshold for detection of “flickering” by the unaided human eye. For example, a typical eye can detect flickering (temporal separation) of an equal intensity light source at intervals as low as 15-25 ms (e.g., app. 40-60 Hz).

Thus, in some variations, it may be desirable to configure the device to operate at a resonant frequency that is greater than (or equal to) the threshold for detection of “flicker” so that the area illuminated by the illumination device appears as solid to an observer. The resonant frequency at which the device operates may be determined based on the intended use for the device or the environment in which the device operates. For example, a handheld device may typically be operated at a resonant frequency between about 10 to 60 Hz (e.g., approximately 40 Hz). A fixed illumination device (e.g., a non-handheld device) may be operated at a slightly higher resonant frequency, e.g., between about 60 and 120 Hz. (e.g., approximately 72 Hz). As described below, the operational (e.g., resonant) frequency may be configured based on the power source (e.g., AC current), and may be adjusted by adding spring components, dampening components, or other modifying elements.

FIGS. 1A and 1B illustrate a proof-of principle of a device as described herein. In FIG. 1A a light source having a circular beam pattern (a spot) is projected directly on a target surface, shown as a calibrated wall. The beam pattern has a diameter 101 that is fixed by the optics of the light source. In FIG. 1B the same light source is used in conjunction with a resonant engine (not shown) having a mirror and a bias, and a mirror driver that oscillates the mirror at or near a resonant frequency of the mirror and bias. The spot is projected onto the moving mirror. The mirror is oscillating abound a neutral position (e.g., 0°) through a positive and negative angle of deflection, which may be based on the bias (e.g., ±45°). As a result, the spot of light from the light source is effectively scanned over the target. The frequency of oscillation of the beam of light (for this single mirror example) is equivalent to the frequency of light of the oscillation of the mirror. The result is a perceived illumination pattern on the target that is a field of view having a much larger diameter 103 than the static spot 101 shown in FIG. 1A. The mirror and bias (or mirror subsystem) may be moved in a very energy-efficient manner by driving them at or near resonance.

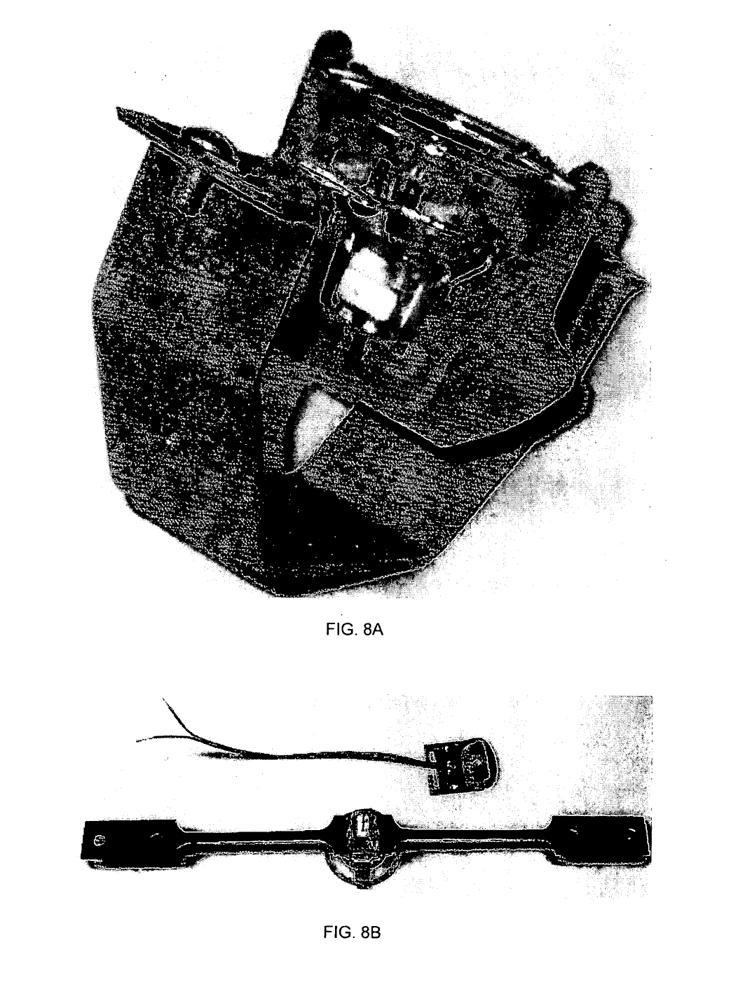

FIG. 9A shows a block diagram describing the relationship between some of the elements that may be included in the resonant engine devices and systems for illumination described herein. As mentioned above, a resonant engine may include a mirror (or mirrors) coupled to a bias, as indicated by the solid line. The mirror and bias may form a mirror subassembly. At least a portion of the mirror subassembly may be mounted to a housing. In general, the mirror is operably connected to the bias, and the bias is connected to the housing (thus, the mirror is connected to the housing through the bias). In some variations, the mirror is included within the housing, while in some variations the mirror is not located within the housing.

A mirror driver may also be included within the housing. Examples of mirror drivers are provided below. In general the mirror driver applies force to load and/or unload the bias. In particular, the mirror driver may apply force so that the mirror subassembly oscillates in resonance. The mirror driver may be controlled by a controller, as indicated by the solid line between the two in FIG. 9A. The controller may include control logic for controlling the power applied to the mirror driver, or for otherwise regulating the force applied to the bias by the mirror driver. In some variations the controller receives input from one or more sensors that feed back into the controller to help regulate the force applied by the mirror driver, thereby helping the mirror subassembly to move at or near resonance. For example, motion of the mirror subassembly may be monitored by an optical sensor. In some variations, a sensor may monitor the load seen by the mirror driver when driving the mirror subassembly. In some variations, a magnetic or magnetic pick-up sensor may be used. Control logic may use this information as feedback to regulate the force applied by the mirror driver.

As mentioned above, one or more lights may also be included as part of the system or device. For example, a light may be included within the housing.

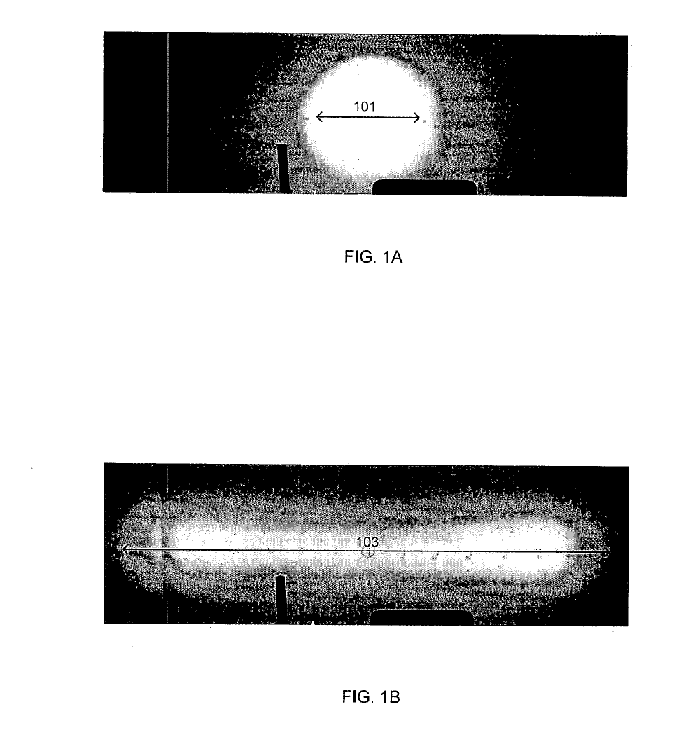

Various examples of resonant engines and resonant engine systems for illuminating an area are described below, including additional detail about each of the components shown schematically in FIG. 9A. Additional elements may also be included, such as (but not limited to) mounting brackets, lenses, filters, power supplies, bearing(s), alignment components, windings, circuitry or the like. In some variations, the resonant engine includes one or more light sources as part of the resonant engine, or a system including a resonant engine. This is illustrated in FIGS. 2A-7.

FIGS. 2A and 2B show schematic cross-sections through a variation of a resonant engine device having a light source integral to the resonant engine, and within the housing of the device. In FIG. 2A the light source 203 is an elongated bulb (e.g., a linear fluorescent bulb, a linear halogen bulb, a linear incandescent bulb, flash lamp, an array of LEDs, etc) that is fixed to a housing 220. The light source may be fixed directly to the housing, or it may be attached to a stem or other positioning device to position the light source with respect to the mirror. The arrangement of the light source and mirror is described more fully below. FIG. 2B shows the same device shown in FIG. 2A in cross section through the center of FIG. 2A.

The device shown in FIGS. 2A and 2B also includes a mirror driver configured to move the mirror and thereby project light in a desired illumination pattern (e.g., illuminating a broad area). In this example, the mirror subassembly includes a bias 205 (e.g., a spring) attached to the mirror 201. A mirror driver 207 which allows the mirror to move with respect to the housing 220, includes a magnet 209 attached to the back of the mirror 201, and an electromagnetic coil 207 opposed to the magnet 209. The mirror subassembly is free to oscillate within the housing 220 because either (or both) ends of the bias are attached to the opposite ends of the housing 220 in this example. In operation, the electromagnetic coil 207 can be excited by electrical current to create a magnetic field that interacts with the magnet 209 to load the bias 205 and thereby move the mirror 201 around the light source 203, projecting the light from the opening in the housing 220 in the process. The bias (e.g., an elastic member) is configured to move or twist as the magnetic field applies force. The bias may then return the mirror back to the original (neutral) position by turning off the magnetic field, or by altering the polarization of the magnetic field. The motion of the mirror may be guided by the bias 205. The electromagnetic coil acts on the magnet and imparts torque (or moment) to move the mirror, pushing against the bias. The bias exerts a restoring torque in the opposite direction to guide the mirror as it moves back to the starting position. In this example, energy may be saved when oscillating the mirror rapidly, because the bias may be used to store some of the mechanical energy required to displace the mirror, and this stored energy may be released to unload the bias and push the mirror past the neutral position.

Although this example shows a mirror driver comprising a magnetic coil interacting with a magnet (or paramagnet) mounted to mirror (e.g., by gluing, etc.), any appropriate mirror driver may be used, and the components of the mirror driver may be arranged in any appropriate fashion. For example, the mirror maybe moved by other mechanisms (e.g., by pneumatic, hydraulic, etc.). In some variations, the mirror is biased in one direction (e.g., by a spring or springs) and force is applied against the bias. Other examples of mirror drivers may include (but are not limited to) motors, voice coil motors, reciprocal electromagnetic drivers, piezoelectric drivers, rotary solenoids, linear solenoids, etc.

In one variation, the mirror, or a portion of the mirror, is itself a magnetic or paramagnetic. Thus, a magnetic field may “push” or “pull” the mirror to cause the movement. The mirror is attached to the illumination device housing 220 by the bias (as show in FIG. 2A), or it may be connect to a pivot (e.g., an axel, rocker, etc.) about which it moves within the housing. The bias may be any appropriate structure for storing and releasing mechanical energy imparted to move the mirror. For example, the bias may be a spring or a material or structure having elastic properties. The bias may be a leaf spring, a coil spring, etc. The bias may be any appropriate material (e.g., elastic materials, metals, rubbers, polymers, etc.). The bias may be selected or modified to control the resonant frequency of the mirror movement. For example, the resonant frequency may be modified by increasing or decreasing the elasticity of the bias by changing the shape, weight, force, tension, load or position of the bias, including the position of attachment to the housing or to the mirror or another element functionally connected to the mirror.

The housing 220 may be any appropriate shape. The resonant engine device housings may include attachment sites for one or more light sources, as well as electrical connections for providing power to the mirror driver(s) and any light sources. The housing may includes an opening or a light-permissive (e.g., transparent) opening to allow the light to enter and/or exit the housing. In some variations, the inner walls of the housing may also be reflective, or may include additional mirrors for guiding the light emitted by the light source onto the movable mirror or otherwise out of the housing. The housing may be shaped to contain the light source and/or mirror, and may be adapted for mounting, attachment, or handheld use.

Any appropriate mirror or reflective surface may be used as part of a resonant engine. The mirror typically comprises at least one reflective surface, which may be completely reflective or selectively reflective. The mirror may be any appropriate reflector (including curved reflectors). In some variations, the mirror is made of a reflective material. In some variations, the mirror includes one or more reflective coatings. The shape of a particular mirror used as part of a resonant engine may be coordinated with the light source to optimize the perceived illumination pattern and/or the rate of scanning of the illumination source over the target illumination pattern. For example, a mirror having two or more reflective surfaces directed to illuminate the target area may effectively double the scanning rate. In this case, for every single oscillation of the mirror subassembly, two or more beams of reflected light are moved to form the perceived illumination pattern.

The “perceived illumination pattern” refers to the pattern of light (illumination) cast by the device in operation, as seen by a person using the illumination device. In general, the perceived illumination pattern covers the entire region over which the light from the light source is reflected. For example, in some variations, an oval or approximately rectangular perceived illumination pattern is projected by the illumination device (e.g., See. FIG. 1B). It is referred to as a “perceived” illumination pattern because the pattern is only perceptible when scanned, since it is formed only by the oscillation of the resonant engine's mirror subassembly.

In some variations, the mirrors may be flat, while in other variations, the mirrors may be concave (e.g., may have a parabolic cross-section), allowing focusing and projection of the light emanating from the nearby light source. A parabolic mirror may focus and project light from the light source due to the geometric properties of the paraboloid shape. For example, if the angle of incidence to the inner surface of the mirror equals the angle of reflection (as is usually the case), then any incoming light that is parallel to the axis of the mirror will be reflected to a central point, or focus. Parabolic mirrors can thus be used to collect and concentrate light, or similarly diffuse light. Energy radiating from the focus can be transmitted outward in a beam that is parallel to the axis of the mirror's concavity. As mentioned above, compound mirrors, having multiple reflective surfaces, may be used. A compound mirror may include both curved and flat surfaces.

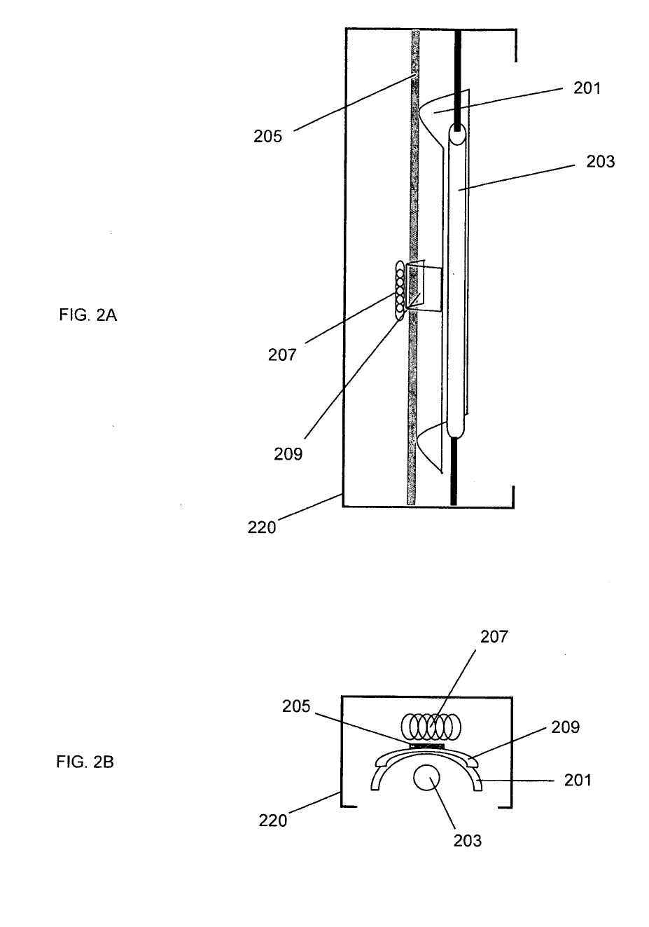

In some variations of the resonant engine in which a light source is included, the mirror may at least partially enclose the light source (e.g., partially surround it). Multiple mirrors may be used with the resonant engine, including mirrors or reflective surfaces that are not part of the movable mirror subassembly. In some variations, a combination of movable and immobile (relative to the housing) mirrors may be used. For example, a fixed mirror may be used in addition to a movable mirror, to capture light that the movable mirror misses, and project this light from the illumination device (or onto the movable projector and out of the illumination device). FIG. 3 shows one exemplary arrangement in which multiple mirrors are used.

In FIG. 3 a fixed central parabolic mirror 301 moves back and forth around a central region 305 to project light in a wide-angle perceived illumination pattern. Two additional mirrors 307, 307′ are included at either side of the central mirror. These additional mirrors are also curved, so that light is projected back into the central mirror 301. Thus, a movable mirror may be at least partially surrounded by a fixed mirror (or mirrors) to prevent additional loss of the light.

A secondary (or third, fourth, fifth, etc.) mirror may also be used. The secondary mirror may be placed separate from (e.g., around) the primary moving mirror, and may be designed to achieve an optimal illumination pattern or optimal distribution of light at a target. In some variations, multiple mirrors may be moved separately. For example, in some variations some of the mirrors are in resonant movement wile others are fixed (e.g., relative to the housing). A multi-mirror system may be used to achieve an optimal pattern or optimal distribution at the target. In some variations, multiple illumination patterns are achieved using a multiple mirrors in which different mirrors are all are in resonant movement. The resonant movement may be in different directions or at different resonant frequencies. Mirrors may be positioned and/or moved to achieve an optimal pattern or optimal distribution of the illumination pattern at multiple targets.

A resonant engine device or system may also include multiple light sources. Thus a single resonant engine device may include a plurality of light sources and/or a plurality of movable mirrors. The same movable mirror may be used with more than one light source. As described above, more than one mirror may be used with a single light source. In one variation, a single resonant engine device may project a perceived illumination pattern in which a first light source is projected in one direction at a resonant frequency and a second light source is projected in another direction at a resonant frequency. These lights may be projected in overlapping or non-overlapping patterns. For example, the light may be projected in complimentary patterns, thereby enhancing the intensity of the perceived illumination pattern while reducing any scanning artifacts. In some variations, light may be projected over a predetermined (or adjustable) angle. For example, a resonant engine may project light over 60°, over 90°, over 120°, over 180°, over 270°, or over 360°.

In some variations, the resonant engine may be used to achieve dimming and color mixing. For example, a light source of one color may be scanned over a target area using a resonant engine and a second light source of a different color may be scanned over the target area with a different resonant engine, or the same resonant engine (using same or a different mirror). If two or more resonant engines are used to illuminate the same area, the resonant engines may be coordinated. For example, the resonant engines may be linked or otherwise synchronized. Thus, each color may be scanned at a different rate and/or over a different area to achieve different color dimming and color mixing. As will be understood, there are numerous ways that dimming and/or color mixing may be achieved. For example, the power to the different light sources may be modulated, the scan rates of the mirror(s) reflecting the different lights may be modulated differently, or both. Other methods to achieve dimming and color mixing are known, including Pulse Width Modulation (PWM) schemes such as that set forth in U.S. Pat. Nos. 6,618,031, 6,510,995, 6,150,774, 6,016,038, 5,008,595, and 4,870,325, all of which are incorporated herein by reference as if set forth in their entirety. PWM schemes pulse the LEDs alternately to a full current “ON” state followed by a zero current “OFF” state. The ratio of the ON time to total cycle time, defined as the Duty Cycle, in a fixed cycle frequency may determine the time-average luminous intensity. Varying the Duty Cycle from 0% to 100% correspondingly varies the intensity of the LED as perceived by the human eye from 0% to 100% as the human eye integrates the ON/OFF pulses into a time-average luminous intensity.

In many of the examples described herein, the mirror is moved by rotating or translating the mirror with respect to a light source, which is typically fixed. However, many of these same principles described herein also apply to resonant engine devices in which a light source moves with (or in addition to) the mirror. For example, some types of bulbs (e.g., MR16, MR11, LED's with optics, etc.) include attached mirrors. In some variations, these light sources may be moved in addition to the mirror. Thus, the mirror subassembly may include a light source.

In operation the mirror subassembly typically moves with respect to the housing at a resonant frequency, and thus the mirror may be configured to move in a substantially undamped fashion, reducing the energy required to move it. In general, this means that the mirror subassembly is fixed (e.g., connected to the housing) at only one or two points. Further, the mirror may comprise a light weight material (e.g., metal alloys, plastics, etc.). The reflective surface may be a coating, or the entire mirror may comprise a reflective material. Thus dampening effects due to contact between the mirror subassembly and other components may be minimized.

Although many of the variations described herein include stiff or somewhat stiff movable mirrors which move with respect to the light source and/or housing, the movement of the mirrors (e.g., directing the light from the illumination source in a perceived illumination pattern) may alternatively (or additionally) be achieved by modulating the shape of the mirror as well. For example, a reflective material (e.g., foil, paper, etc.) may be bent, twisted, shaped, or otherwise manipulated to project the light from the device to help form the perceived illumination pattern.

The arrangement of the light source and the movable mirror subassembly may be chosen to optimize the distribution and intensity of light emitted by the illumination device. For example, mirrors such as parabolic mirrors or mirrors with additional lenses or lens properties (as described below) may have a focus from which light is concentrated and projected to form the perceived illumination pattern. The movable mirror and light source may be arranged so that the light source is offset from the focus of the light mirror. In particular, the mirror may be positioned so that the light source is closer to the mirror than the focus (or plane of focus). In addition, the light source is may be arranged so that it does not interfere with the range of motion of the movable mirror or the projected illumination pattern.

Additional elements may be included for shaping or conditioning the perceived illumination pattern. For example, optical features such as optical lenses may be included. A lens (or lenses) may be used to focus and/or defocus light projected from the resonant engine device. A lens may help “spread” the light projected from the light source so that it more uniformly illuminates the illumination pattern. Texture, pattern or peen may also be applied to the mirror to achieve a more uniform illumination of the perceived illumination pattern. “Peen” typically refers to a dotting or machining process that pits the surface of the mirror to soften or diffuse the reflected light.

A perceived illumination pattern may be non-uniform in intensity when the light emitted by the illumination device is moved or oscillated uniformly. This non-uniformity of illumination may be desirable or undesirable based on the lighting application. For example, refer back to FIGS. 1A and 1B to compare the illumination pattern of the static light source (shown in FIG. 1A) to the illumination pattern provided by the same light source used with a resonant engine device in which the light is scanned (as shown in FIG. 1B). The region illuminated by the scanned light 103 in FIG. 1B is many times larger than the un-scanned illumination 101 in FIG. 1A, however the field may be non-uniform in intensity due to the rate and pattern of oscillation of the resonant engine. In the example shown in FIG. 1B, the mirror and light are moved at a constant rate, approximately equal to the resonant frequency of the illumination device (e.g., back and forth along a single axis). The perceived illumination pattern in FIG. 1B appears to have a non-uniform intensity, resulting in a somewhat barbell-shaped (or batwing-shaped) pattern in which the regions at either end of the illumination pattern appear slightly brighter (and therefore larger) than the regions in the middle of the pattern. When the mirror subassembly is oscillated back and forth at a constant (or approximately constant) frequency, the mirror (and/or light source) appears to change direction at the ends of the perceived illumination pattern. The time between periods of illumination at the end regions therefore has a different interval than the regions closer to the middle of the pattern. At lower frequencies this apparent difference in the time interval between illumination of the same area may result in an apparent difference in the uniformity of the illumination pattern.

The resonant engine may correct for this non-uniformity by changing the frequency or rate that the mirror is moved (in particular, by increasing the rate), or by changing the pattern in which the mirror is moved. For example, the resonant engine may be scanned in two dimensions (e.g., up-down, and side-to-side). In some variations, a desired illumination effect is achieved by modifying the mechanical system to create a more linear or continuous movement. For example, the resonant engine may include an additional bias that is extended at or near the ends of the range of motion, where the mirror changes direction. The additional bias feature may alter the speed that the mirror through the extreme end regions. These secondary mechanics may modify the mirror movement to achieve an optimal pattern or optimal distribution at the target.

The mirror subassembly may be moved in two-dimensional resonance. For example, a two-dimensional mirror movement can be used to achieve a more uniform, special shape or larger illumination pattern. In some variations, the mirror is moved in three dimensional resonances. Movement of the mirror (or mirrors) in three dimensional motion may further help achieve an optimal pattern or optimal light distribution pattern.

In general, the mirror (or other movable portions of the resonant engine, such as a light, a lens, or additional mirrors) may be moved or oscillated in any appropriate manner. As described above, a mirror may be moved in one dimension (e.g., oscillating back and forth or up and down), in rotation, in two dimensions (e.g., any combination of back and forth, up and down, rotation, etc.) or in three dimensions (including in and out). Each dimension of motion may be separately controlled (e.g., using an individual mirror driver), or may be driven by the same mirror driver. Each dimension of motion may be controlled to regulate the perceived illumination pattern.

Optical features such as lenses may also be included as part of the resonant engine. Lenses may be used to help distribute the light over the illumination pattern. For example, the resonant engine may include a lens which is particularly helpful for diffusing the illumination pattern (e.g., widening it, or minimizing non-uniform intensity). A lens may be attached to the mirror, or it may be separate from the mirror. In some variations, the lens may be attached to the housing. In some variations, the lens may move with the mirror, or independently of the mirror. A lens may be placed between the light source and mirror or between the mirror and target. More than one lens may be used. A lens may also be used to help focus light from the light source. Other optical features may also be used. For example, a lens may be used to polarize or filter light from the light source.

Any of the light sources referred to herein may be collimated and/or highly concentrated light sources. Collimated light may be particularly desirable. In general, collimated light is light in which the light rays are parallel, and may therefore have a plane wavefront. Light can be collimated by a number of processes, including shining it on a parabolic concave mirror with the source at the focus. Collimated light is sometimes said to be focused at infinity. In some variations, coherent light may be used (e.g., light from a laser source). In some variations, coherent light is excluded.

The resonant engines described herein may use light sources that emit light of any appropriate wavelength and/or intensity. For example, the light source may be a traditional light source (e.g., an incandescent, florescent, halogen, etc.), an infrared light source, an ultraviolet light source, a heat lamp, or some combination thereof.

The lighting source may be fixed (e.g., relative to the resonant engine or to the housing of the resonant engine) or it may be movable. For example, the lighting source may be movable separately from the movable mirror. In some variations the resonant engine is adapted to be used with an existing light or lamp. Thus, the resonant engine may retrofit an existing light or lamp. In some variations the resonant engine may include an adapter to direct light from an existing lamp or illumination source towards the mirror (or mirrors) of a resonant engine. This adapter may include a lens or other collimator.

In some variations, a resonant engine may also improve energy efficiency by allowing a light source to be powered by discontinuous power. For example, the discontinuous power may be generated as an interrupted DC signal having a duty cycle or a non DC waveform (e.g., an AC waveform). The frequency that power is supplied to the light can be chosen at or above a predetermined frequency so that the light source is “on” long enough to be perceived without “flicker,” as described above for the movement of the mirror. Desired light distribution may also or additionally be achieved by modulating intensity of the light source(s). Such effects can be gained through fast response solid state lighting (e.g., LEDs) or through the use of multiple lamps. Modulation of the intensity may be relative to the resonant frequency of the resonant engine to create a desired effect and/or desired light distribution.

In variations in which the mirror (or light source) is moved at a resonant frequency, the rate or frequency of the power applied to the light source may be coordinated with the rate of movement. The frequency that power is supplied to the light source (the light power frequency) may be coordinated or modulated with the rate of movement of the mirror (e.g., the movement frequency) so that the apparent illuminated field is more uniformly illuminated. For example, the two frequencies may be timed so that the light source is “on” more when the mirror is aiming the light source in the center of the illumination field, compared to the edges (which may otherwise receive almost twice as much light). The discontinuous power supplied to the light source may therefore be “on” more than it is “off”, or may be “on” for different periods or intervals. For example, the discontinuous power supplied is not limited to sinusoidal signals (e.g., the duty cycle may be greater than 50%). In some variations, the power to the light source is modulated in time relative to the timing of the resonant system (e.g., matched to the resonant frequency or harmonics of the resonant frequency).

The frequency of power to the light may be related to the frequency of oscillation of the mirror subsystem. In some variations, the light power frequency is regulated by the frequency that power is applied to move the mirror. In some variations, the frequency that power is supplied is regulated by the supplied power (e.g., AC current). In addition to reducing the total power required to operate the resonant engine, regulating the power applied to the light source may also extend the lifetime of the light source.

Resonant engines in which the mirror does not move may also be used. For example, it may be beneficial to improve the energy usage of a static resonant engine by applying discontinuous power to the device. Furthermore, discontinuous power may be applied to resonant engines where the light source and the mirror both move, or where the light is fixed but the mirror subassembly moves. For example, the light may be pulsed or strobed. The power supplied to move the moveable portions of a resonant engine may also be regulated. For example, the power supplied to move a moveable mirror at resonance may be supplied from the alternating frequency power commonly available from utility companies. Thus, the resonant frequency source may be based on directly adapting the frequency of this wall current. For example, alternating current generated by most utility companies typically comprises a very stable 50 hertz or 60 hertz component. This frequency component can be utilized to effectively move a mirror. As described herein, the mirror may moved by a mirror driver that includes a motor, a voice coil motor, a reciprocal electromagnetic driver, a piezoelectric driver, a rotary solenoid, a linear solenoid, or any other appropriate component.

In general, any appropriate power source or supply may be used, including DC energy sources (such as a battery, fuel cell, solar cell or similar energy generating device), and AC energy sources (e.g., wall current). The choice of power supply may depend upon the use or configuration of the resonant engine. For example, the resonant engine may be configured for exterior, portable and/or mobile applications.

Any of the resonant engines described herein may be part of an illumination system (i.e., a resonant engines for adjustable light system). Resonant engine systems may include an illumination source (e.g., a light source), a mirror configured to move at a resonant frequency, a bias, a housing, and/or any of the components described herein, including duplicate components such as additional mirrors and light sources. In some variations, the system includes a power supply or a power supply conditioner for adapting the power supplied to the light source, a movable mirror, or both.

Illumination systems may also include mounts or attachments for positioning or securing the illumination device to a surface or in a desired position. For example, the illumination source may be mounted to a tripod or stand. The illumination source may be mounted to a wall or rooftop.

Any of the devices or systems described herein may be used for any appropriate purpose, particularly when illumination of a large or controlled area requiring only low power would be beneficial. For example, the described resonant engines may be useful by protective service agents such as police and fire personal, for maintenance and laborers whom depend on illumination, or for automotive or mobile applications. The resonant engines described herein may be particularly useful where only limited power sources are available, or where the light source is important for safety or productivity.

In operation, the resonant engines described herein may be operated by one or more user controls. For example, a user control (e.g., switch, dial, button, etc.) may be present on the outside of the housing. A power switch may be provided to turn the device “on” or “off”. In addition, a user control may be provided to activate or regulate different portions of the resonant engine. For example, a user control may be provided to select or adjust the resonant frequency that the mirror (and/or illumination source) oscillates. Thus, in some variations, the resonant engine may be used in different modes, including a narrow-field mode (in which the mirror subassembly is not oscillating), a wide-field mode (in which the mirror subassembly is oscillating). In some variations, the width of the filed (e.g., the lateral extent to which the mirror subassembly moves during an oscillation) may be adjusted or controlled in one or more dimensions. This may be referred to as control of the scan angle of the illumination source. In some variations, a brightness control may also be included. The brightness control may regulate the power supplied to the light source, or may activate/deactivate additional light sources, or may selectively attenuate, or may modulate the brightness intensity in a manner synchronous to the resonant frequency, etc.

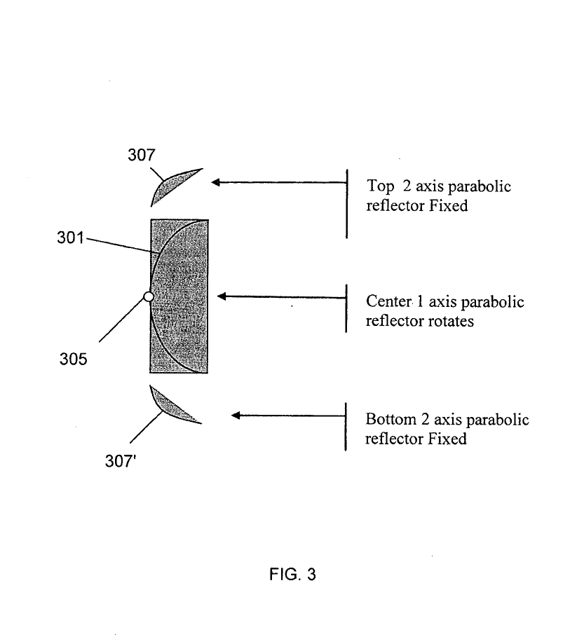

FIGS. 4-8 illustrate another variations of the resonant engines described herein. As mentioned above, these devices may be used as part of any illumination system, and may be used, for example, as stairwell lighting, hallway lighting, exterior sign lighting, Interior down lighting, shop light (e.g., when used with a tripod), or as part of consumer electronic lighting products.

FIG. 4 shows an exploded three-dimensional view of a resonant engine as described herein. In this variation of a resonant engine, the light source 403 is a linear bulb (e.g., a linear incandescent bulb) which is attached to the upper 421 and lower 425 walls of the housing 423, in front of the mirror 401. The mirror is configured to move at a resonant frequency (e.g., between 40 and 120 Hz). In operation, the mirror 401 moves around the light source 403 by flexing the bias 405. The bias (or spring) is attached to the mirror along the longitudinal midline of the mirror. Thus, the movement of mirror may be balanced, allowing maximum movement at the resonant frequency. The bias is also attached to the top and bottom of the housing. In some variations (not shown) the mirror may include stops which may limit the movement of the mirror and prevent damage to the light source by the motion of the mirror. In another variation, the stop may be elastomeric and accelerate the bias movement reshaping the beam pattern and or light distribution.

When assembled, the resonant engine shown in FIG. 4 has a rectangular opening through which the light may be projected to form the illumination pattern. This opening may be covered with a transparent surface (e.g., glass, plastic, etc.).

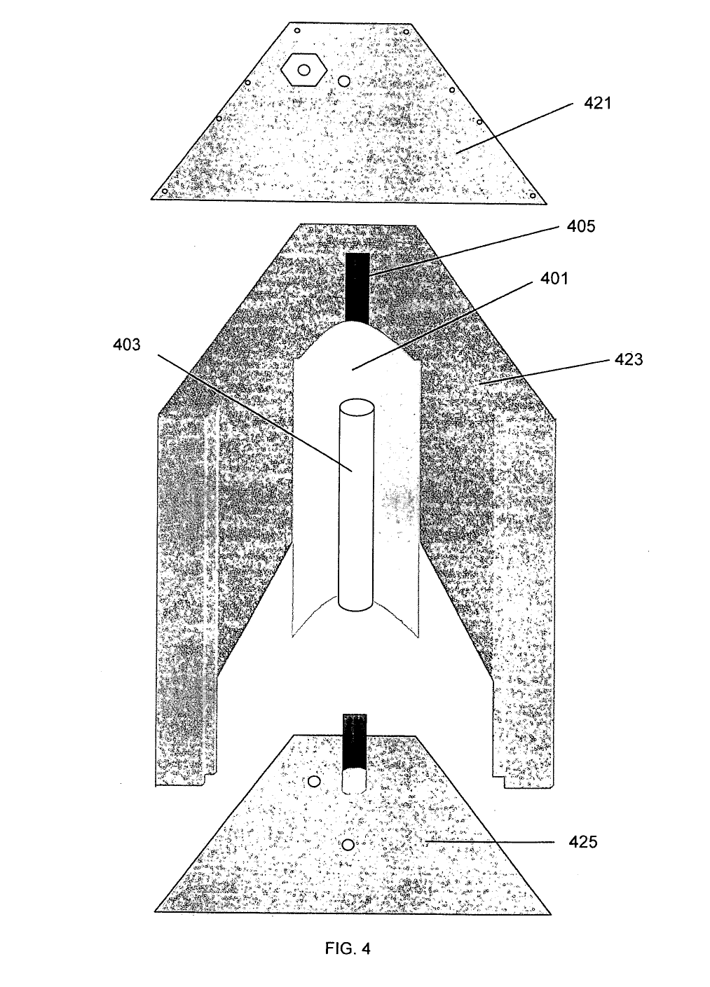

FIG. 5 illustrates a cross-section through the middle of a resonant engine similar to the one shown in FIG. 4. This resonant engine also includes a mount 510 for mounting the device to a wall, a stand, etc. The mount is located at the back of the device, opposite from the opening through which light is projected. The mount (or additional mounts) may be located in any appropriate location on the resonant engine. The cross-section shown in FIG. 5 also shows a mirror driver comprising an electromagnetic coil 507 which is configured to interact (e.g. apply electromagnetic force against) a magnet 509 or paramagnetic substance attached to the back of the reflective surface 501. Inducing an alternating magnetic field by the electric coil may “push” and/or “pull” the mirror, resulting in movement. As describe more fully below, movement of the mirror should optimally be performed at a resonant frequency.

In the arrangement shown in FIG. 5, the mirror is attached to a bias 505, shown located between the light source 503 and the mirror 501. The bias may be positioned in any appropriate position. In this example, the bias is located along a center (midline) of the mirror, as described previously, and is also located at focal point so that as the mirror rotates (e.g., by twisting or otherwise deforming the bias), the magnets or paramagnets mounted on the back of the mirror keep an adequate (or a constant) distance from the electromagnetic coil. The elements shown in the figures are not necessarily to scale. For example, the electromagnet coil may be more uniformly separated from the mirror and/or magnets.

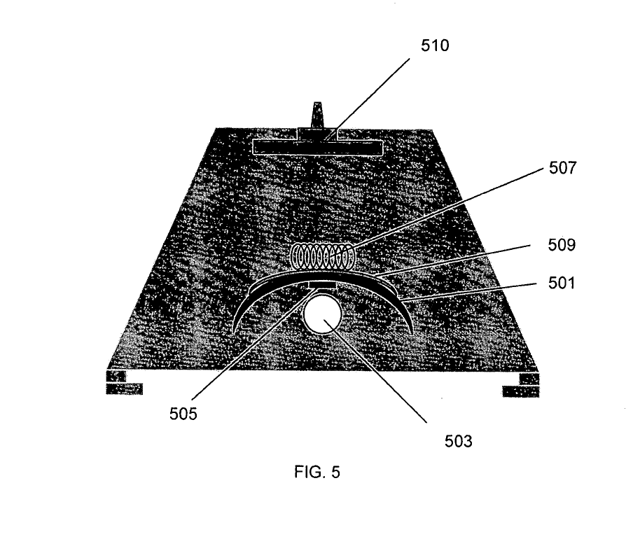

FIG. 6 shows a partial cross-sectional view of a resonant engine similar to that shown in FIGS. 4 and 5. This cross-section is taken through the long axis of the resonant engine.

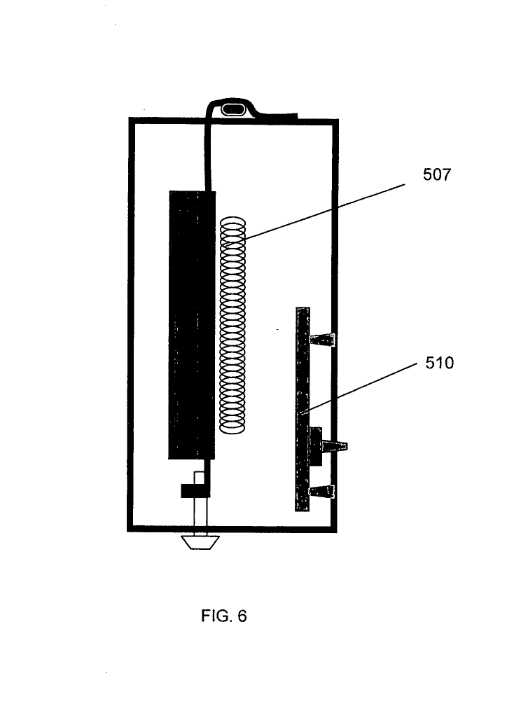

FIG. 7 illustrates a schematic of a resonant engine having an elongated light source (e.g., bulb) and a mirror with a parabolic reflective surface reflecting light from the light source. A bias (shown as a spring 705) is attached to the mirror at the longitudinal midline of the mirror. Thus, the mirror may be moved at the resonant frequency for this system (e.g., 50-130 Hz), as previously described, to produce an illumination pattern. In some variations, the bulb may be off during part of the movement cycle (e.g., when the mirror faces the extreme edge regions of the pattern), which may modify the illumination pattern (e.g., to minimize or reduce uneven illumination of the pattern).

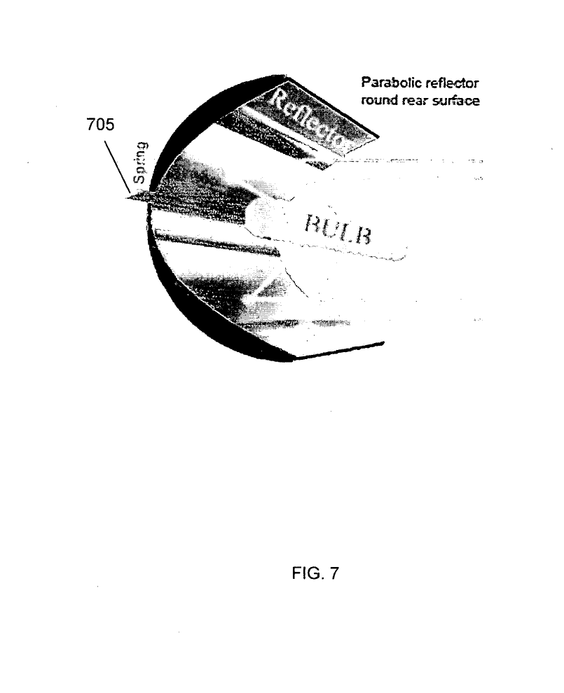

FIGS. 8A and 8B illustrate another variation of a resonant engine as described herein. In FIG. 8A, the resonant engine comprises a combined mirror and light source (e.g., a MR16 type bulb), which may be oscillated together to form the illumination pattern, as described above.

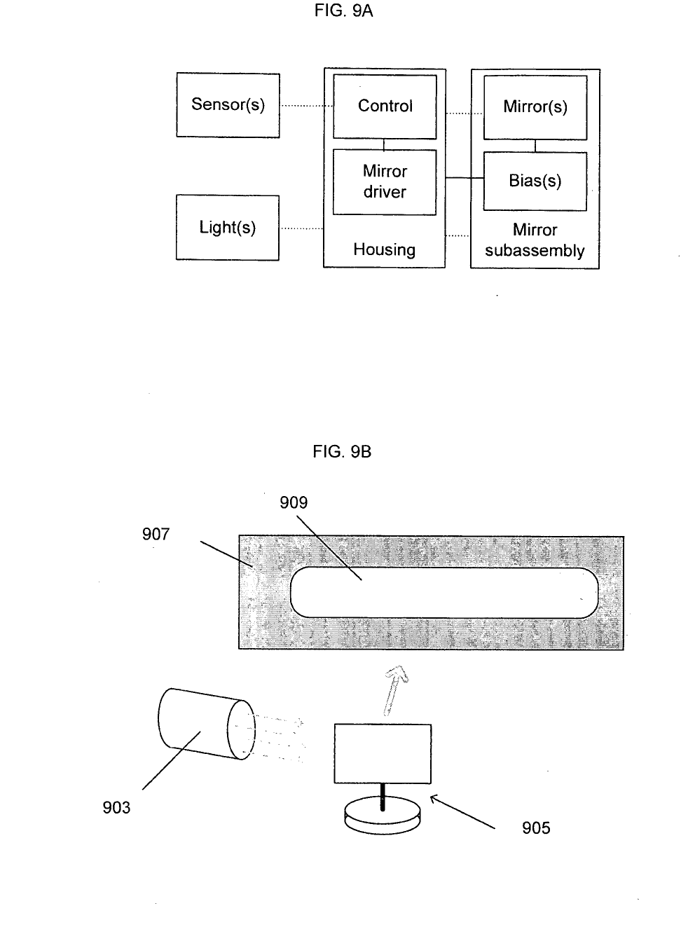

FIG. 9B shows a schematic of a resonant engine system. This system includes a resonant engine 905 (having a mirror, bias and mirror driver), and a light source 903. The light source provides collimated light that is directed towards the resonant engine. Collimated light from the light source is reflected off of the oscillating mirror of the resonant engine 905 against the target (screen 907), where it forms an illumination pattern 909. The particular variation of the resonant engine is shown in greater detail in FIG. 10.

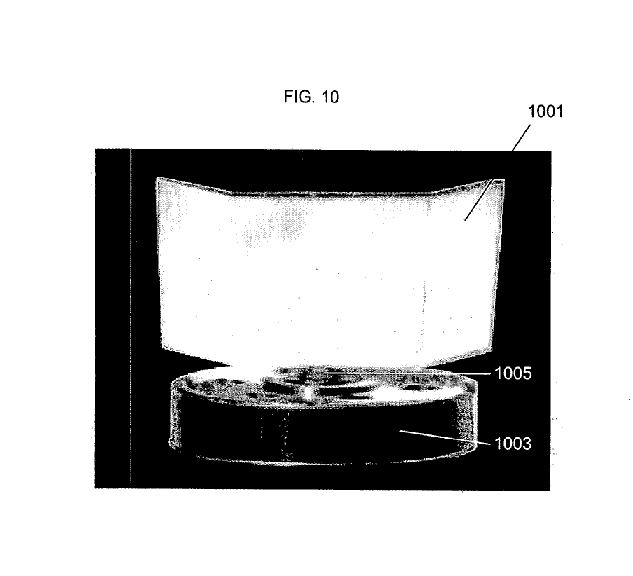

FIG. 10 shows a resonant engine that does not include a light, and has a mirror 1001 having three panels that are each flat and reflective (on at least one side). Each mirror panel is positioned at an angle with respect to the other. The mirror 1001 is attached to a rotor 1005 that is in turn connected to a bias (not shown) within the housing 1003. An external light (e.g., a collimated light as shown in FIG. 9B) may be positioned so that the emitted light reflects off of the mirrors when the mirror subassembly oscillates. Additional details for this variation of the resonant engine are described in FIGS. 11-14.

In some variations, including the device shown in FIG. 10, the bias is a spring, such a clock spring. FIG. 11A shows one variation of a bias configured as a clock spring. In general, a clock spring is a coiled spring, in which each coil nests inside the next larger one. A clock springs typically has two ends. The first end may be located at the center of the coils and may attach to a central shaft (i.e., a rotor) may be attached. The second end at the end of the outer coil may be mounded to the housing (or structure that communicates with the housing, to secure the spring within the housing. Typically, the clock spring exerts torsional force between the central shaft and the housing. Clock springs can be made from a variety of materials, including (but not limited to) metals, alloys, polymers, rubbers, or combinations thereof. For example, a clock spring may be made from beryllium copper or similar alloys, or high-carbon steel.

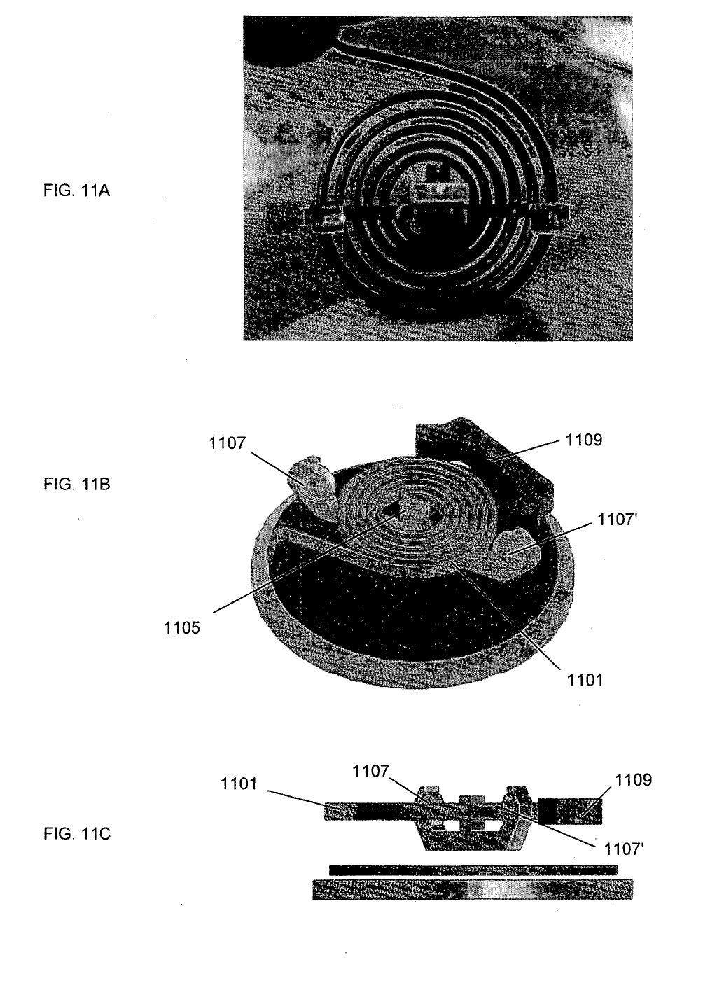

The clock spring 1101 shown in FIG. 11A has six nested coils. The center of the clock spring 1101 may be mounted to shaft, to which the mirror may be connected. In FIGS. 11A-11C, the center of the clock spring 1101 is mounted to a rotor 1105. The rotor may be part of the mirror driver, as described above. In the variation shown in FIGS. 11A-11C, the rotor 1105 includes two magnetic poles 1107, 1107′ which are fixed magnets that will interact with a magnetic field generated by a stator 1109. The stator 1109 may also be a component of the mirror driver, as described in more detail below. The rotor 1109 is fixed to the center of the clock spring 1101 and has a generally “T” shaped structure in which the arms of the “T” pass beneath the plane of the clock spring (defined by the coils). The fixed magnets 1107, 1107′ of the rotor are positioned at the ends of these arms, and are each centered in the same plane as the coils of the clock spring 1101. By positioning the magnets of the rotor in the same plane as the clock spring coils, out-of-plane bending or torque may be avoided. Although not shown in FIG. 11A-C, the rotor may project upwards through the plane of the coil and may provide a mounting surface for connection to the mirror(s). This is shown in more detail in FIGS. 12A and 12B. In some variations, the “T” shaped rotor has arms that fit both above and below the plane of the clock spring coils.

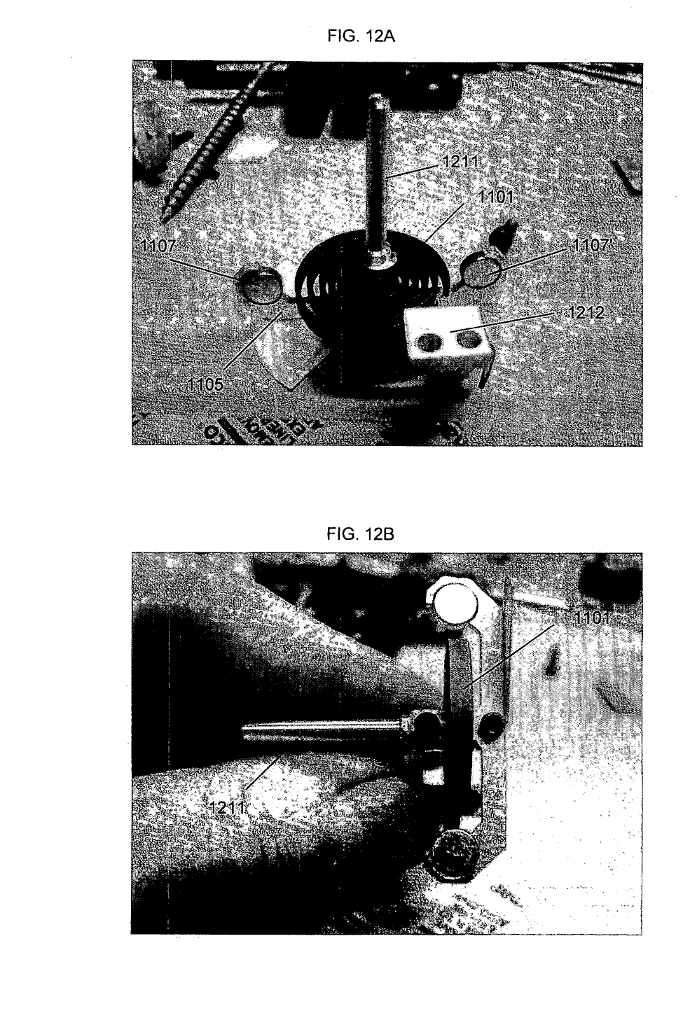

FIGS. 12A and 12B show a clock spring 1101 to which a rotor 1105 having two fixed magnets is attached. A post 1211 for mounting the mirror (not shown) may be attached to the center of the clock spring 1101 and/or the center of the rotor 1105. The mirror-mounting post may include a surface, clamp, screw, or the like for securing the mirror. In some variations, the mirror is directly connected to the center of the clock spring or to the rotor, and does not require an additional post. FIG. 12A also shows the housing mount 1212 for securing the clock spring (and therefore the entire mirror subassembly) to the housing. The subassembly housing mount 1212 shown is a bracket that secures the bias (clock spring) to the housing so that this end of the bias is effectively fixed with respect to the housing. FIGS. 13A-13D show schematic illustrations of many of the components of the resonant engine of FIGS. 10-12C.

FIGS. 13A and 13B show a side and front view, respectively, of a mirror 1301 that may be mounted to the resonant engine. This mirror is similar in design to the mirror shown in FIG. 10. Although FIGS. 13A and 13B indicates dimensions (in mm) for the mirror 1301, these dimensions are only exemplary. The mirror may be smaller (e.g., less than 10 mm long) or larger (greater than 50 mm long), and may be matched to the dimensions of the beam of light received by the light source or sources used. In some variations, the mirror 1301 is between about 1 mm and 500 mm wide and between about 1 mm and 500 mm tall.

FIG. 13C shows a side view of the mirror shaft (including a clamp) 1305 and the rotor 1317. The mirror shaft may therefore be clamped to the rotor 1317. As previously mentioned, the dimensions are only intended to illustrate one variation of the device. FIG. 13D shows a top view of the mirror subassembly (including mirror 1301, rotor 1317, clock spring 1309) that has been positioned within the housing 1311, so that the rotor 1317, including fixed magnets 1307, 1307′ are positioned adjacent to the stator 1313 that can produce a magnetic field that acts on the rotor to load and unload the bias 1309. In this variation, the stator and rotor are both components of the mirror driver.

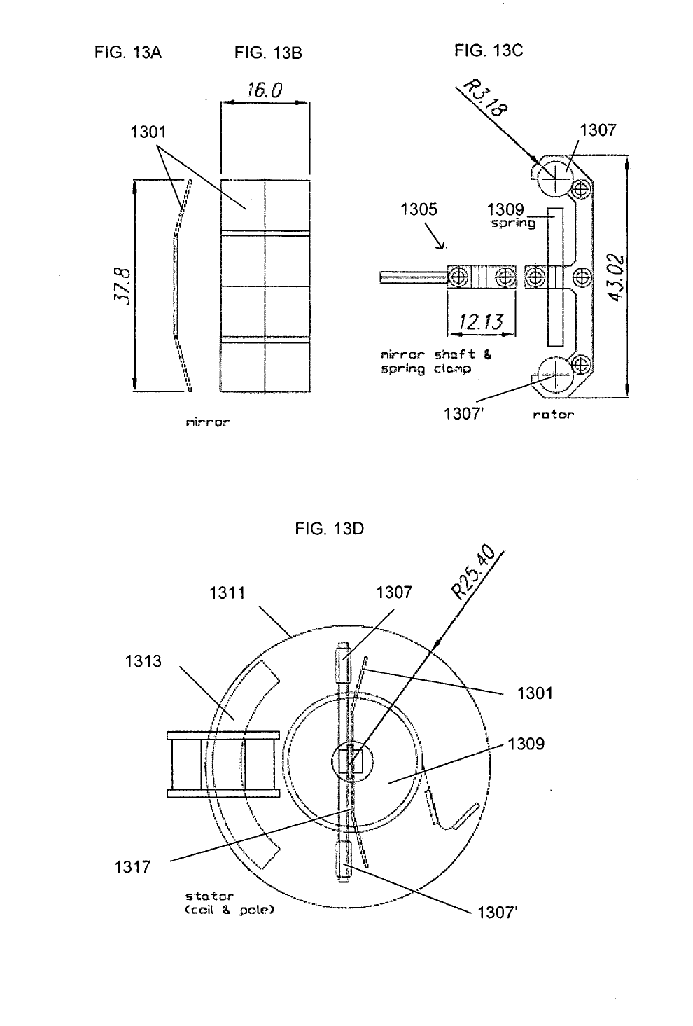

FIGS. 14A-14C show perspective, top and side cut-away views, respectively, of the portion of the resonant engine included within the housing 1411. For the sake of simplicity, the mirror portion of the resonant engine is not shown in these figures. The side perspective view shown in FIG. 14A shows the housing 1411, within which the mirror subassembly and at least a portion of the mirror driver are mounted. As described above, the mirror subassembly in this example includes a clock spring 1409 and rotor 1417 mounted in the center of the clock spring. The rotor includes two fixed magnets 1407, 1407′. The mirror subassembly is mounted in the housing only by the connection between the outer end of the clock spring 1409 and the housing mount 1419, so that the plane of the clock spring is parallel to the bottom of the housing. Thus, the mirror subassembly is suspended within the housing 1411, and is free to move in a substantially undamped fashion. This is apparent in FIG. 14C, which shows a cross-section through a perspective view of this example of a resonant engine taken through line C-C′ of FIG. 14B. The suspension of the mirror subassembly above the base of the housing is also apparent in FIG. 11C.

FIG. 14C also shows control circuit 1425 included as part of a printed circuit board (PCB) on the base of the housing. The control circuitry may include executable control logic for controlling the oscillation of the mirror subassembly. In particular, the control circuitry may be configured to control the motor driver so that force is applied to the mirror subassembly so that it moves at a resonant frequency. In FIGS. 14A-14C the motor driver includes the stator 1417 that is part of the mirror subassembly and the stator 1421. The stator 1421 includes a coil or winding and a pole. As previously mentioned, the stator generates an electromagnetic field that exerts force on the mirror subassembly. In some variations, this applied electromagnetic field exerts force by attracting and/or repelling the rotor 1417 (e.g., the magnets 1407, 1407′ attached to the rotor 1417)

Force applied by the stator loads (and/or unloads) the clock spring 1409 of the mirror subassembly. The loading and unloading of the clock spring results in the twisting (typically in the plane of the clock spring) of the mirror subassembly, and therefore the mirror. The force applied by to the mirror subassembly is typically related to the strength and orientation of the applied electromagnetic field emitted by the stator, and the stator may be controlled by the control circuitry 1425. The control circuitry may control the power supplied to the electromagnetic field. In particular, the control circuitry may regulate the stator so that the electromagnetic field applied drives the mirror subassembly in resonance.

Thus, the control circuitry may provide variable, pulsatile power to the mirror driver (e.g., stator) to both start the mirror subassembly oscillating, and thereafter to oscillate the mirror subassembly at or near a resonant frequency. In some variations, the control circuitry includes control logic that may maintain the steady-state resonant oscillation of the system. In some variations, the control circuitry may include one or more feedback loops that determine resonance of the mirror subassembly based on sensing either the motion of the mirror subassembly and/or the back electromagnetic force (EMF). Thus, one or more sensors (e.g., optical sensors, electrical sensors, motion sensors, etc.) may be used to provide information to the control circuitry. As used herein, “circuitry” may be any appropriate circuitry, including hardware, software, firmware, or some combination thereof, and is not limited to PCBs.

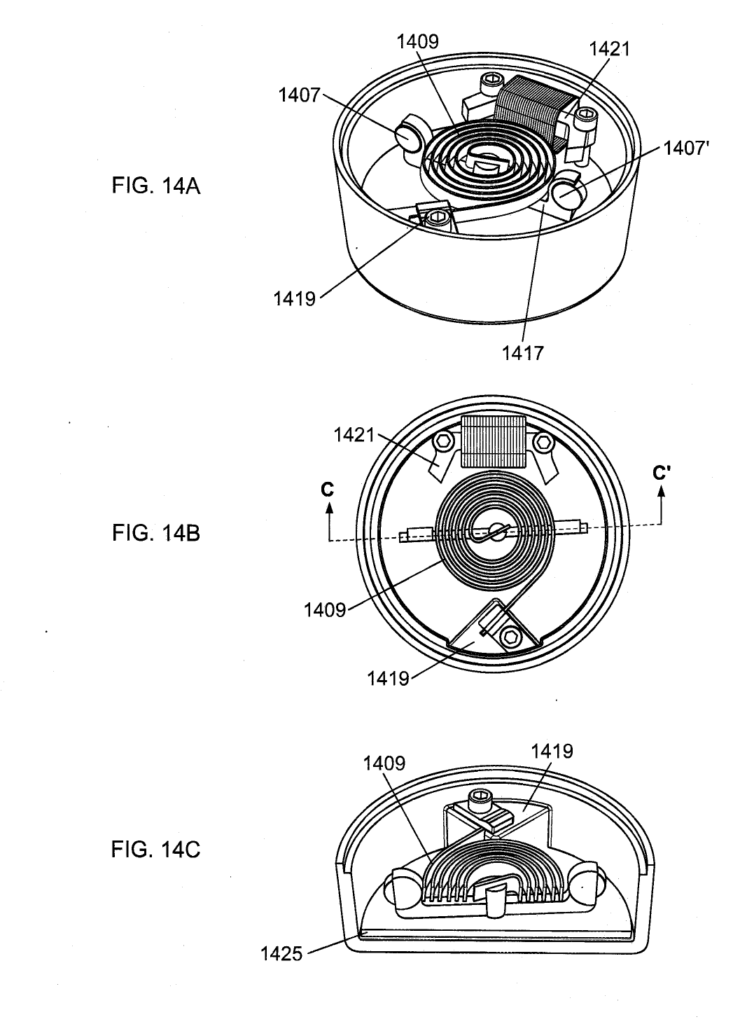

FIGS. 15A-15C illustrate another variation of a resonant engine in which the bias is a blade or bar, rather than a clock spring. Referring now to FIG. 15B, the resonant engine is shown in the neutral position, in which the mirror has a zero deflection (i.e., is centered in the range of oscillation). This variation of the resonant engine includes a mirror subassembly having a mirror 1501 connected to a bias 1503. The mirror subassembly is connected to the housing 1507 through mount 1512, by securing the bias near one end. The mirror 1501 is secured to the opposite end of the bias, and the bias and mirror are free to move (i.e., oscillate) in an undamped fashion. A light source 1530 is attached to the housing as well, and a collimator 1535 surrounds the light source so that emitted light is directed to towards the mirror 1501 of the mirror subassembly. The light source and collimator are mounted to the housing in a fixed position relative to the movable mirror subassembly, by means of a bracket 1537.

A fixed magnet (or magnetically permeable material) 1505 is attached to the bias 1503. The magnet 1505 forms a part of the mirror driver that also includes a voice coil 1509 which generates a magnetic field to attract or repel the fixed magnet, and can therefore cause deflection of the mirror subassembly and therefore the mirror. FIGS. 15A-15C also show a sensor 1540 that can provide information to the control circuitry (not shown). As previously mentioned, any appropriate sensor may be used, including (but not limited to) optical sensors, mechanical sensors, electromagnetic sensors, or the like.

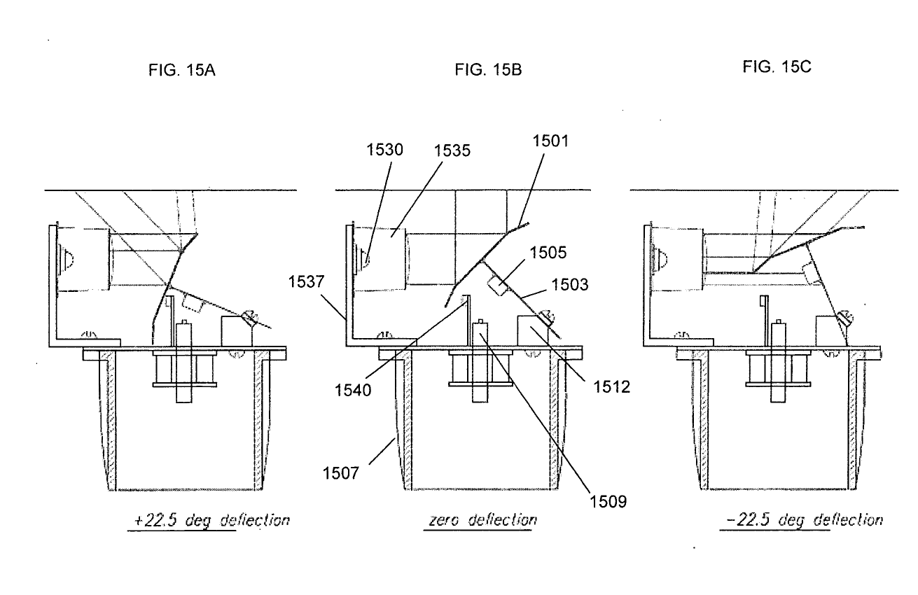

Referring to FIG. 15A, the mirror subassembly may be drawn towards the housing (positive deflection) by the application of energy to the voice coil, which applies electromagnetic force to attract the magnet 1505 and bend the bias 1503 downward. In this example the mirror subassembly is deflected downward by 22.5°, causing collimated light from the light source 1530 to be reflected off of two sides of the mirror 1501. Thereafter, the voice coil may either decrease, reverse, or turn off the emitted electromagnetic field, allowing the mirror subassembly to return towards the neutral position, as shown in FIG. 15B, or pass the neutral position and continue to move towards the position shown in FIG. 15C, which is deflected by −22.5° (negative deflection). As the mirror subassembly oscillates, the reflected light from the mirror is scanned over the target. In this variation, the mirror includes three flat regions. Thus, this mirror is one variation of a compound mirror, having three reflective regions. Each of the three reflective regions therefore produces a reflection of light that is scanned over the target to form the illumination pattern. Because of this, the effective scanning rate for light over the target is greater than twice the rate of oscillation. Thus, as previously mentioned, the scan rate and the quality of the illumination pattern may be improved by using more than one mirror, or by using a compound mirror as shown in FIGS. 15A-15C. This is further illustrated in FIGS. 16A-16D, 17A-17F, 18A-18F.

FIG. 16A shows a profile of a single-faced, flat mirror. FIGS. 16B-16D illustrate scanning of the single-faced mirror shown in FIG. 16A. In all of these figures, the light source (not shown) is positioned to the left of the mirror profile. In the neutral position shown in FIG. 16C, the flat mirror 1601 is shown positioned at a 45° angle from the light source. Since the angle of reflection is equal to the incident angle, light is reflected off of the mirror a 45° angle in FIG. 16C. FIG. 16B shows the reflection of light when the mirror is deflected upwards, moving the reflected light to form the right side of the illumination pattern 1603. Similarly, as the mirror is deflected in the opposite direction, the reflected light is scanned to the left. As the mirror is oscillated, the entire illumination pattern 1603 is illuminated by this scanning. In this example, the single, flat mirror scans the reflected light at twice the rate that the mirror is oscillated (e.g., a single spot of light travels across the illumination pattern twice for every cycle of mirror movement (e.g., backwards and forwards).

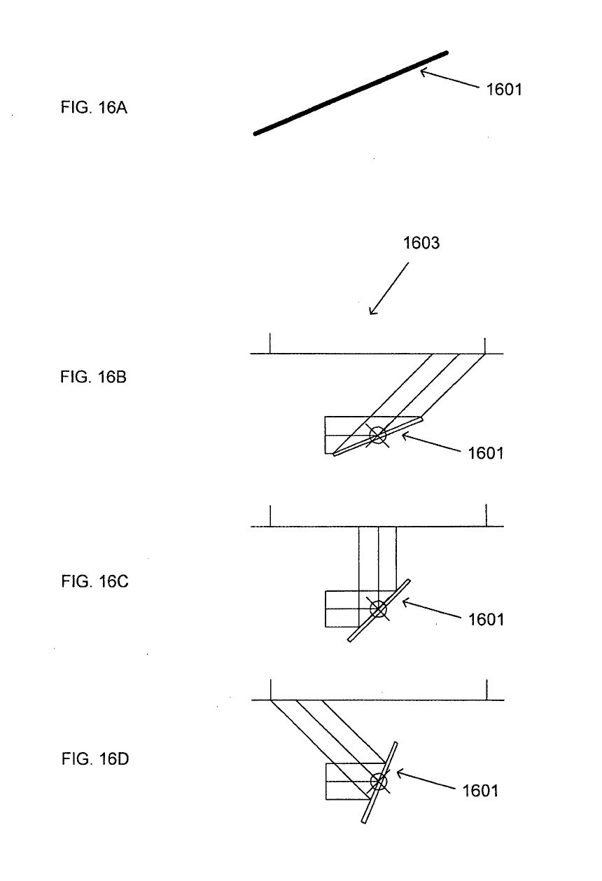

FIG. 17A shows a mirror having a compound profile, in which the mirror comprises three flat regions positioned at an angle with respect to each other. As previously described for FIGS. 15A-15C (which illustrated a similar compound mirror), each face of the mirror may reflect the light at a slightly different angle, resulting in multiple scanning reflections forming the illumination pattern. In this example, the mirror may be angled so that some of the light from the light source is lost (e.g., not reflected by the moving mirror), as shown in FIGS. 17B and 17C. In FIGS. 17B-17F, as the mirror is deflected upwards from the neutral position of FIG. 17D, the mirrored regions on either side of the mirror reflect light to the edges of the illumination pattern. However, when the mirror is deflected downwards from the neutral pattern, only the central region of the mirror illuminates the illumination pattern. Thus, the illumination pattern is formed by a variable scanning rate depending on the deflection of the mirror during the oscillation. In practice, the effect of scanning the edges of the illumination pattern during positive deflection may result in a more uniform or brighter perceived illumination pattern.

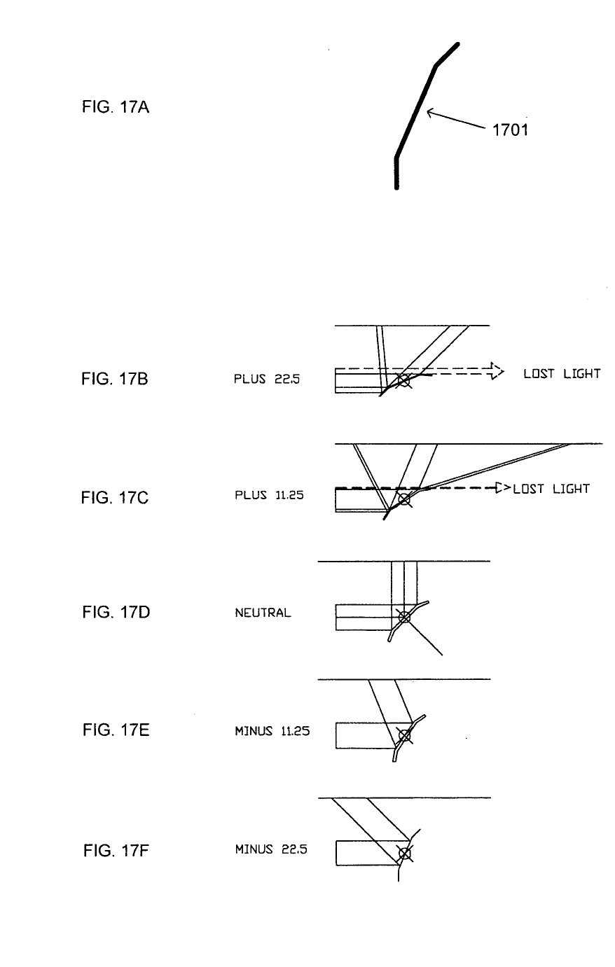

FIG. 18A shows another variation of a compound mirror profile for a mirror having four fat regions. FIGS. 18B-18F illustrate the formation of the illumination pattern as the mirror is oscillated. FIG. 18D shows the neutral position, while FIGS. 18B and 18F show the extreme upwards and downwards displacement, respectively.

As previously mentioned, any appropriate mirror may be used, including curved mirrors, or mirrors that include both concave and/or convex regions, multifaceted regions and flat regions. In some variations, the mirrors are non-flat shapes, and may have three-dimensional cross-sections such as polygonal (e.g., triangular, rectangular, pentagonal, hexagonal, heptagonal, octagonal, etc.) cross-section.

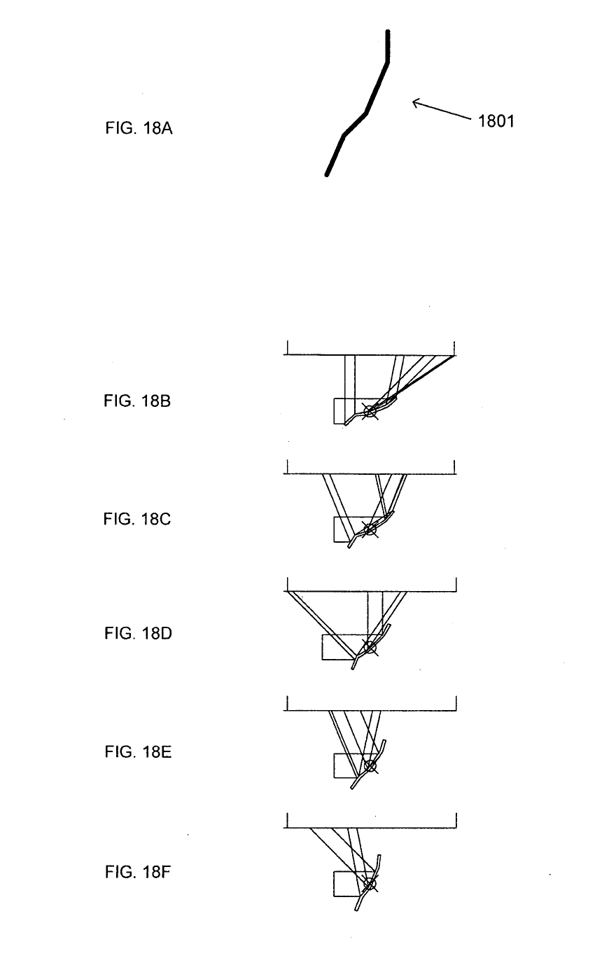

FIGS. 19A-19B show one variation of a resonant engine configured as a galvanometer-type device, in which the mirror subassembly includes a mirror having a hexagonal cross-section. In this variation, the resonant engine includes the mirrored outer shell 1901. A mirror drive consists of both a multi-pole magnet 1905 distributed as an annular ring within this reflective core, and a stator 1907 having a coil and a pole. FIG. 19B shows two clock springs 1909, 1909′, each attached to the center of the oscillating mirror (including the multi-pole magnet). The outer end of each clock spring is attached to a housing 1911, and may be decoupled by rubber to minimize additional vibration. Current through the stator 1907 induces an electromagnetic field, causing the mirrored shell to rotate and load/unload the biases. Thus, the mirror may be oscillated.

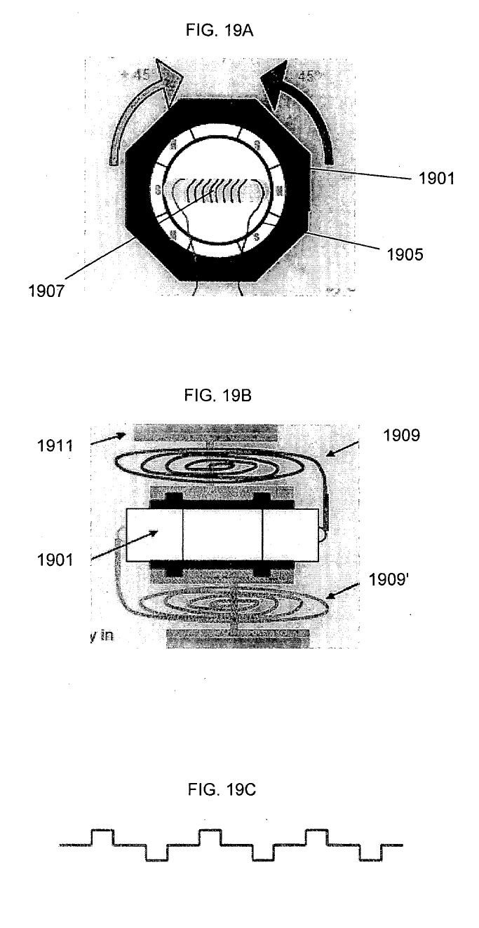

FIG. 19C shows one variation of a drive signal (e.g., current or voltage profile) supplied to the motor to create the magnetic field and move the mirror subassembly (e.g., bias and mirror) in the embodiment of FIGS. 19A and 19B. By changing the polarity of the drive signal the direction of the force applied is changed. FIGS. 20A and 20B illustrate the operation of a resonant engine similar to that described in FIGS. 19A-19B.

In FIGS. 20A-20B, two light sources 2001, 2001′ are used with the resonant engine. Each light source is collimated by a collimating lens 2003, 2003′, and the mirror subassembly is oscillated (e.g., at ±45°) at a resonant frequency by the application of current through the stator. In any of the variations described herein either a single illumination pattern (overlapping the multiple reflections of light) may be formed, or a multiple illumination patterns may be formed. Thus, an illumination pattern may be formed by overlapping the scan patterns of different mirrors.

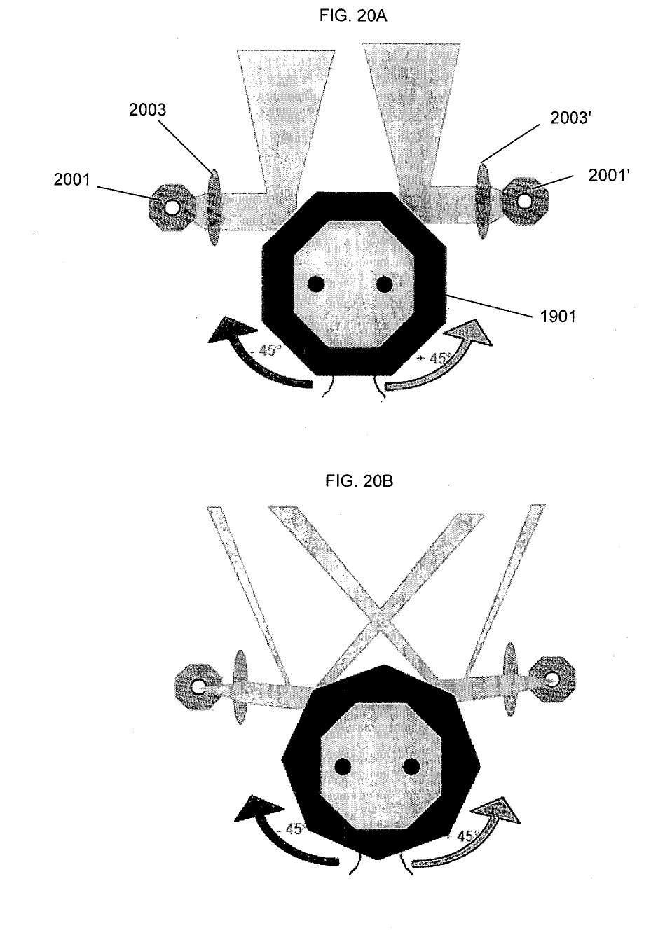

FIGS. 21A-21C, 22A-22C, 23A-23B, and 24A-24C show different mirrors or reflectors that may be used, particularly with the galvanometer-type design described above. For example, FIG. 21A shows a mirror having a hexagonal cross-sectional profile. A side perspective view of this same mirror is shown in FIG. 21B, and FIG. 21C illustrates an example of the reflection pattern of such a mirror, when it is used with two light sources.

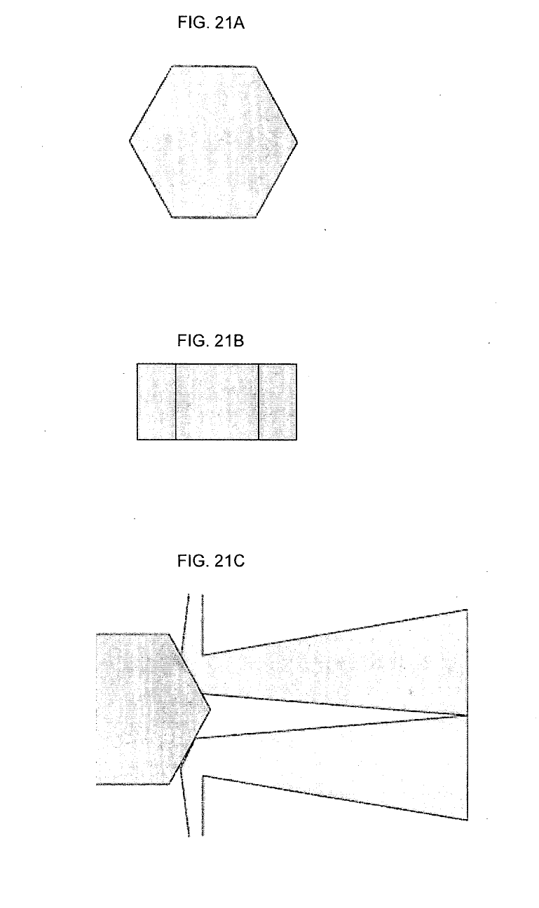

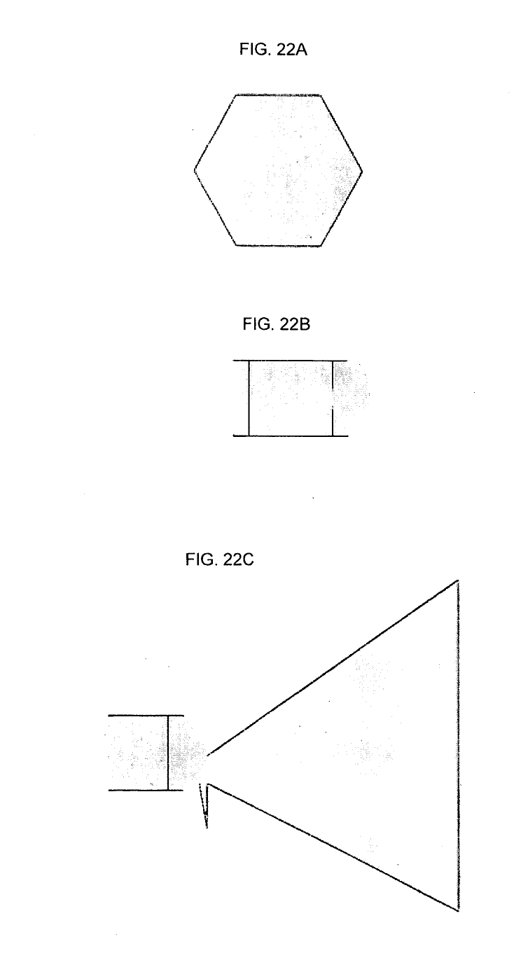

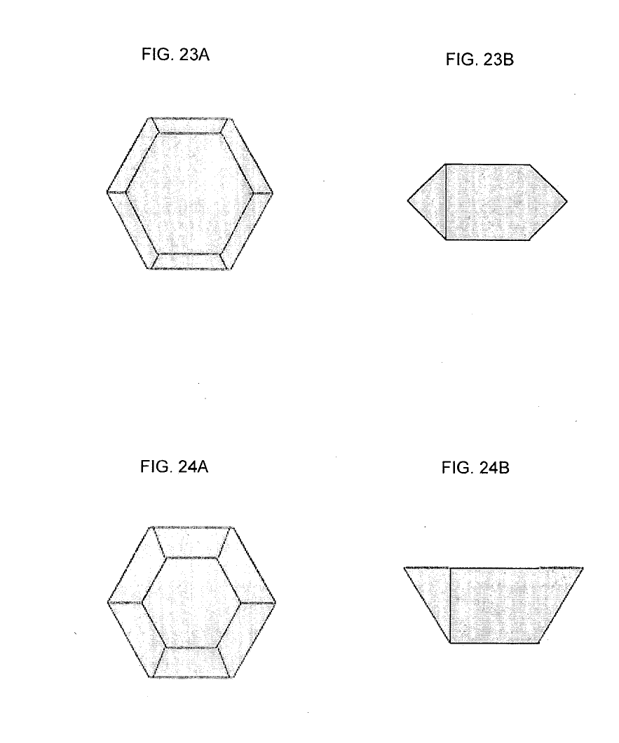

FIG. 22A-22C shows a similar mirror, in which the reflector has a curved profile, as shown in FIG. 22B, which may result in spreading the reflected light, as shown in FIG. 22C. Mirrors may also have angled reflective surfaces that may create a wider spread for the illumination pattern, as shown in FIGS. 23A and 23B, showing both a top view and a side view, respectively. FIGS. 24A and 24B illustrate another variation of the mirror similar to that shown in FIGS. 23A and 23B.

Additional examples of resonant engine described herein also include devices that are within, part of, or adapted for use with an incandescent light bulb. Thus, the resonant engine may be within the bulb itself (e.g., within the vacuum chamber of the bulb) so that light from the filament is reflected by the mirror. In any of the variations described herein, the resonant engine may be adjustable so that the pattern of light formed by the resonant engine and light source is adjustable by a user. For example in the incandescent bulb variation described above, a bulb including a resonant engine may be screwed (or otherwise inserted) into a light socket such as an overhead light socket, and controlled by a switch on the wall, which may adjust the illumination area, and otherwise power the device.

In some variations of the devices described herein, the mirror subassembly includes a light source. For example, an LED or other optic for illumination may be mounted to (or part of) the bias, so that vibration of the mirror subassembly at a resonant frequency moves the light source as well as the reflector. In some variations, the mirror is not a planar or flat mirror, but is a reflector that condenses or directs light from the light source on the mirror subassembly. Thus, the mirror may comprise a lens as well as, or in addition to, the reflective surface.

The above detailed description is provided to illustrate exemplary embodiments and is not intended to be limiting. For example, any of the features of an embodiment may be combined with some or all of the features of other embodiments. Furthermore, although the majority of examples described herein are specific to visible light, it should be clear that the devices, systems and methods described herein apply to non-visible regions of the electromagnetic spectrum. For example, the illumination source described herein may be a UV, IR, or other illumination source, and the mirror may be a reflector compatible with such an illumination source. Exemplary uses of the resonant engine for non-visible light include laser levels, ultrasound measurements, night vision for cameras, and leak detection.

It will be apparent to those skilled in the art that numerous modifications and variations within the scope of the present invention are possible. Throughout this description, particular examples have been discussed, including descriptions of how these examples may address certain disadvantages in related art. However, this discussion is not meant to restrict the various examples to methods and/or systems that actually address or solve the disadvantages. Accordingly, the present invention is defined by the appended claims and should not be limited by the description herein.

What is claimed is:

1. Apparatus for maintaining oscillation of a moveable subassembly including a mass and a bias, the apparatus comprising:
a controller operable to:
receive a signal from a sensor associated with a position or motion of the subassembly, and
output a drive signal for driving the assembly at or near a resonant frequency in response to the received signal from the sensor.

2. The apparatus of claim 1, further comprising a sensor operable to sense a position or motion of the subassembly.

3. The apparatus of claim 1, further comprising a force transducer for receiving the drive signal and driving the subassembly.

4. The apparatus of claim 1, wherein the subassembly comprises a mirror.

5. The apparatus of claim 4, wherein the controller is operable to output drive signals to a force transducer to move the mirror at or near a resonant frequency.

6. The apparatus of claim 4, wherein the controller outputs drive signals to oscillate the mirror at greater than 10 Hz when driven.

7. The apparatus of claim 4, further comprising at least one sensor operable to generate a signal associated with the position or motion of the mirror, wherein the controller receives the signal.

8. The apparatus of claim 4, wherein the mirror is configured to receive and reflect light from an illumination source, and the mirror is operable to move in an oscillating motion or repetitive motion.

9. The apparatus of claim 1, further comprising a common power source for driving the mirror and the illumination source.

10. The apparatus of claim 1, wherein the subassembly comprises a resonant engine comprising a mirror operatively connected to a bias, wherein the bias is mounted to an engine support, and the bias is configured to move the mirror with respect to the engine support in an oscillation motion.

11. The apparatus of claim 10, further comprising a mirror driver configured to move the mirror at or near a resonant frequency by selectively loading the bias.

12. The apparatus of claim 1, wherein the controller is operable to modulate the drive signal over time based on the received signal from the sensor.

13. The apparatus of claim 1, wherein the controller comprises logic for modulating the drive signal, the logic selected from the group consisting of: software, firmware, or hardware.

14. The apparatus of claim 1, wherein the subassembly is controlled in a one dimensional linear or rotational mode of movement.

15. The apparatus of claim 1, wherein the subassembly is controlled in a two dimensional planer or rotational mode of movement.

16. The apparatus of claim 1, wherein the subassembly is controlled in a three dimensional volume or rotational mode of movement.

17. An illumination device for selectively controlling a movable mirror, the device comprising:
a subassembly comprising a mirror and a bias;
a sensor for sensing movement or motion of the subassembly and generating a signal associated therewith;
a controller configured to receive the signal from the sensor and output a drive signal for driving the subassembly, wherein the controller is operable to modulate the drive signal to move the subassembly in response to the signal received from the sensor.

18. The device of claim 17, further comprising a force transducer for receiving the drive signal and driving the subassembly.

19. The device of claim 17, wherein the controller is operable to output drive signals to a force transducer to move the mirror at or near a resonant frequency or a harmonic thereof.

20. The device of claim 17, wherein the controller outputs drive signals to oscillate the mirror at greater than 10 Hz when driven.

21. The device of claim 17, wherein the mirror is configured to receive and reflect light from an illumination source, and the mirror is operable to move in an oscillating motion or repetitive motion.

22. The device of claim 17, further comprising a common power source for driving the mirror and the illumination source.

23. The device of claim 17, wherein the controller is operable to modulate the drive signal over time based on the received signal from the sensor.

24. The device of claim 17, wherein the controller comprises logic for modulating the drive signal, the logic selected from the group consisting of: software, firmware, or hardware.

25. The device of claim 17, further comprising an illumination source for projecting light to the mirror.

26. A method for controlling oscillation of a mechanical assembly, the method comprising:
receiving a signal associated with the position or motion of a subassembly comprising a mass and a bias; and
outputting a drive signal for driving the assembly in response to the received signal from the sensor, wherein the drive signal is modulated based on the received signal.

27. The method of claim 26, further comprising moving the mass at or near a resonant frequency of the subassembly system.

28. The method of claim 26, wherein the signal is received from a sensor operable to sense a position or motion of the subassembly.

29. The method of claim 26, further comprising outputting the drive signal to a force transducer for operable for driving the subassembly.

30. The method of claim 26, wherein the subassembly comprises a mirror.

31. The method of claim 30, wherein the controller is operable to output drive signals to a force transducer to move the mirror at or near a resonant frequency or a harmonic thereof.

32. The method of claim 30, wherein the controller outputs drive signals to oscillate the mirror at greater than 10 Hz when driven.

33. The method of claim 30, wherein the mirror receives and reflects light from an illumination source, the mirror moving in an oscillating motion or repetitive motion.

34. The method of claim 26, wherein the subassembly comprises a resonant engine comprising a mirror operatively connected to a bias, wherein the bias is mounted to an engine support, and the bias is configured to move the mirror with respect to the engine support in an oscillation motion.
